(19) United States
(12) Patent Application Publication
(10) Pub. No.: US 2026/0252743 A1
(43) Pub. Date: Aug. 27, 2026

(54) SYSTEM AND METHOD TO PROTECT CONTENT SHOWN IN APPLICATION WINDOWS

(71) Applicant: JANUSNET PTY LTD, Sydney, New South Wales (AU)

(72) Inventors: Gregory Alan COLLA, Sydney, New South Wales (AU); Kien Sen HUANG, Sydney, New South Wales (AU)

(21) Appl. No.: 19/132,200

(22) PCT Filed: Nov. 22, 2023
(86) PCT No.: PCT/AU2023/051195

§ 371 Date: May 22, 2025

(30) Foreign Application Priority Data
Nov. 22, 2022 (AU) 2022903536
Dec. 13, 2022 (AU) 2022903813
Jan. 19, 2023 (AU) 2023900118

(51) Int. Cl. G06F 21/84; G06F 9/451

(52) U.S. Cl. CPC G06F 21/84; G06F 9/452

(57) ABSTRACT

A window capture controller, installable into an independent software application operating in a computing environment; said independent software application displaying a window; said independent software application is independent from said window capture controller; said independent software application executing inside process space allocated by said computer environment's operating system; wherein when said window capture controller is injected into said independent software application it remains resident in said independent software application and it remains receptive to commands to selectively control whether said software independent application's window can be captured or not by further screen capture software. Further, a method of selectively preventing capture of content shown in a window of a software application executing on a computer by injecting a window capture controller into said software application.

### TECHNICAL FIELD

The present invention relates to a system and method to selectively protect the content shown in application windows and more particularly although not exclusively to a window sharing security controller.

### BACKGROUND

Many professional organisations today use some type of screen sharing applications (such as Teams, Zoom, Webex or Slack) for collaboration. Such capabilities are also provided by browser applications, such as Google Meet. During a virtual meeting, a presenter can share a screen or application window with the remaining meeting attendees.

The concern of data leakage for organisations is paramount, whether it be personal and private information which an organisation holds about its clients, or commercially sensitive information such as business plans or intellectual property, or international sensitive information that one government knows about another. Regulators can fine organisations for mismanagement of personal and private information. Organisations can be in breach of contractual obligations for leakage of sensitive information. In any case, sensitive information has value, and the leakage of this information can cause harm or damage to individuals, organisations, and governments.

Organisations make their sensitive information available to users via many different applications, including Microsoft Word, or Excel, and other applications, such as Adobe Acrobat Reader, as well as web browsers which can display information from systems such as accounting systems, customer relationship management systems or patient record systems, and industry specific applications, such as AutoCAD as using in manufacturing, or Integrated Development Environments (IDEs) as used by software developers.

Screen sharing has some inherit risk of information leakage. For example, a disgruntled user could share company secrets with a remote user via a screen share. A busy health professional could accidentally share a patient's health records by sharing the wrong application window. Data leakage can also occur by using a screen capture application, such as Snagit, which can take a screenshot of a window or region of a display. Transmission of the image can subvert text-based leakage prevention tools, as the data is no longer text.

Many screen sharing applications have the option to select an individual window to share. By diligently selecting the application to share, the presenter reduces the risk of accidental information leakage, as other applications are not shared. However, during a presentation, when the need arises to change the shared application, the presenter faces a multistep process to change focus back to the screen sharing application, stop sharing the existing application, and locate the new application to share. This can slow the flow of the presentation. Furthermore, it is often the case, that the presenter may not be skilled in the use of the screen sharing application, simply due to lack of experience, or complexity of the screen sharing application, and the presenter could subsequently select the wrong application to share.

There are a number of screen sharing technologies which attempt to address the problem of information leakage via screen sharing. These systems, however, are standalone and do not control screen capture of existing, popular screen sharing technologies such as Slack, Teams, Webex, Goto Meeting or Google Teams.

Berry [1] describes a system which identifies sensitive portions of an application window and displays a derivative of the window with the sensitive portions blurred or otherwise redacted on a second (public) display. Berry describes a “screen grabber” component which requires access to the window content. The screen grabber operates separately from the application associated with the window. The system generates the differentiated view by grabbing “the visual surface of shared application windows” which are then manipulated. The system identifies sensitive portions of the application window using accessibility APIs and application specific APIs. The window manipulation function is integral to the system. It does not function in a generic sense, protecting third-party application windows from third-party windows capture and sharing applications. The system disclosed by Berry will not protect window content from other screen sharing applications, such as MS Teams or Zoom.

Kuchor [2] discloses a system including a chat session and screen sharing between networked computers. The system includes further features including limited sharing of designated privacy applications. As described, this feature is implemented as part of the system and its function only has benefit while windows are shared using this disclosed system's sharing function. It does not function in a generic sense, protecting software application windows from third-party windows capture and sharing applications. As such, a user with another screen sharing application, such as MS Teams or Zoom will not have any benefit from the disclosed system.

Luo [3] discloses a system for optimising the bandwidth requirements for online screen sharing. The operation of this system is partially implemented by the system's client operating on the presenter's desktop, and further implemented by the system's online meeting server. Like Kuchor above, the disclosed system's function only has benefit while windows are shared using this disclosed system's sharing function. It does not function in a generic sense, protecting software application windows from third-party windows capture and sharing applications. As such, a user with another screen sharing application, such as MS Teams or Zoom will not have any benefit from the disclosed system.

Kochura [4] discloses method for safeguarding confidential information during a screen share between networked devices. In this method, its program receives a request to for screen sharing, presumably from the computer user. The method furthermore analyses and summarises content prior to transmission to remote networked devices. Like both Kuchor and Luo above, the disclosed system's function only has benefit while windows are shared using this disclosed system's sharing function. It does not function in a generic sense, protecting software application windows from third-party windows capture and sharing applications. As such, a user with another screen sharing application, such as MS Teams or Zoom will not have any benefit from the disclosed system.

Loeb [5] discloses a method for protecting private content during a shared web session. This method utilizes a ‘service server’, which is accessible to presenter and web session spectators. Dependent on HTML tags of the web page as viewed by the presenter, the service server modifies the view presented to the spectators. Like each of Kuchor, Luo and Kochura above, the disclosed system's function only has benefit while web sessions are shared using this disclosed system's sharing function. It does not function in a generic sense, protecting software application windows from third-party windows capture and sharing applications. As such, a user sharing a window application with a screen sharing application, such as MS Teams or Zoom will not have any benefit from the disclosed method.

Thiyagarajan [6] discloses a customer support application providing screen sharing which obfuscates sensitive information found on the presenter's screen from the remote display. Like each of Kuchor, Luo, Kochura and Loeb above, the disclosed system's function only has benefit when an application window is shared using this disclosed system's sharing function. It does not function in a generic sense, protecting software application windows from third-party windows capture and sharing applications. As such, a user sharing a window application with a screen sharing application, such as MS Teams or Zoom will not have any benefit from the disclosed method.

Titus Inc. [7] shows the hiding of a Word document window based on the security classification of the document. The system is ineffective in many situations, in that the user does not have the choice to share the window, as may be necessary in some cases. It does not allow for the scenario where each virtual meeting attendee is ‘cleared’ to view the word document. Furthermore, the system limits itself to Word documents (and possibly other Microsoft Office application). It does not lend itself to a universal solution, where the sharing of each and any application window on a desktop (including the desktop window) is easily controlled by the presenter in a consistent manner. It is blunt in its operation; in that it does not allow for partial sharing of a document.

Invisiwind [8] shows the hiding of a software application window using a command line program to hide a window based on the application's program identifier. Like the previous example, it is ineffective in many situations. It does not provide a control for the user in the software application to enable or disable the capture and sharing of that window. The application must be running (to have a process identifier before the command line program can hide it. As such, before hiding any application, it is shared. It is also blunt in its operation; in that it does not allow for partial sharing of a document.

A further type of existing implementation to manage screen sharing is based on a more traditional proxy model [9]. In this model, a network component such as a firewall, can block the streaming connection based on the network packet attributes. Such a system uses brute force to block screen sharing connections. It does not allow for a presenter to override the enforcement, as may be necessary in many situations.

In summary, there is a gap in the current field whereby an organisation does not have the ability to enforce which windows on a user's display can be captured by an independent screen sharing software application, an independent video capture software application, or an independent screen capture software application. Furthermore, there is a gap in the current field whereby an organisation does not have the ability to trace and audit the windows on a user's desktop that have been shared by any number of the above independent software display capture and sharing applications.

While these gaps exist, a computer user can accidentally or maliciously leak sensitive information via a screen sharing application. The prior art approaches are singular, or impractical, or deficient in essential functionality.

These problems are addressed by embodiments of the present invention, which provides an easy-to-use, consistent, universal mechanism manage the screen capture and sharing of windows on the presenter's desktop, independent of the screen sharing application.

### REFERENCES

[1] L. Berry, “Role-Based Control Access Views,” Vancouver, 2005.
[2] S. K. Kuchoor, “Application sharing functionality in an information networking environment”. United States of America Patent US 2015/0032686 A1, 29 January 2015.
[3] Z. Luo, “Optimizing Desktop Sharing for Wireless Clients During Network Colloration”. United States of America Patent U.S. Pat. No. 8,924,862 B1, 30 December 2014.
[4] N. KOCHURA and F. Lu, “Safeguarding Confidential Information During a Screen Share Sessions”. United States of America Patent US 2019/0163927 A1, 30 May 2019.
[5] S. LOEB, “Scalable Privacy Protected Web Content Sharing Mechanism for Web Based Applications”. United States of America Patent US 2017/0249394 A1, 31 August 2017.
[6] P. Thiyagarajan and D. L. Kaufman, “Electronic Communication with Secure Screen Sharing of Sensitive Information”. United States of America Patent US 2015/0278534 A1, 1 October 2015.
[7] Titus Inc., “How to prevent capture of protected documents during a Zoom session,” 17 April 2020. [Online]. Available: https://www.youtube.com/watch?v=HH0o-tDExZ4. [Accessed 8 November 2022].
[8] “Invisiwind,” 21 June 2021. [Online]. Available: https://github.com/radiantly/Invisiwind.
[9] AGAT Software, “Security and Compliance for Zoom,” [Online]. Available: https://agatsoftware.com/solution-overview-zoom/. [Accessed 02 Dec 2022].
[10] R. Chen, “Which windows appear in the alt+Tab list?,” 8 October 2007. [Online]. Available: https://devblogs.microsoft.com/oldnewthing/20071008-00/?p=24863. [Accessed 06 December 2022].
[11] Zoom Video Communications, Inc, “Zoom network firewall or proxy server settings,” 2 November 2022. [Online]. Available: https://support.zoom.us/hc/en-us/articles/201362683. [Accessed 13 December 2022].
[12] Microsoft Corporation, “Office 365 URLs and IP address ranges,” 10 June 2022. [Online]. Available: https://learn.microsoft.com/en-us/microsoft-365/enterprise/urls-and-ip-address-ranges?view=o365-worldwide#skype-for-business-online- and-microsoft-teams. [Accessed 13 December 2022].
[13] Cisco Systems, Inc., “Network Requirements for Webex Services,” 15 October 2022. [Online]. Available: https://help.webex.com/en-us/article/WBX000028782/Network-Requirements-for-Webex-Services. [Accessed 13 December 2022].
[14] TeamViewer, “TeamViewer trust Center, Security Overview,” [Online]. Available: https://www.teamviewer.com/en-us/trust-center/security/#teamviewer-ports. [Accessed 12 January 2023].
[15] R. Kuster, “Three Ways to Inject Your Code into AnotherProcess,” 20 August 2003. [Online]. Available: https://www.codeproject.com/Articles/4610/Three-Ways-to-Inject-Your-Code-into-Another-Proces. [Accessed 24 November 2022].
[16] S. B. Bao and R. L. Martin, “Cognitive SCreen SHaring with Contextual Awareness”. United States of America Patent 2018/0253324 A1, 6 September 2018.
[17] Microsoft Corporation, “Event Tracing,” 24 January 2023. [Online]. Available: https://learn.microsoft.com/en-us/windows/win32/api/_etw/. [Accessed 12 September 2023].
[18] Microsoft Corporation, “UI Automation,” 20 August 2020. [Online]. Available: https://learn.microsoft.com/en-us/windows/win32/winauto/entry-uiauto-win32. [Accessed 11 September 2023].
[19] Google, “Alternative extension installation methods,” 17 September 2012. [Online]. Available: https://developer.chrome.com/docs/extensions/mv3/external_extensions/. [Accessed 13 October 2023].
[20] Microsoft Corporation, “Office Add-ins platform overview,” [Online]. Available: https://learn.microsoft.com/en-us/office/dev/add-ins/overview/office-add-ins. [Accessed 13 October 2023].
[21] National Institute of Standards and Technology, “Guide to Attribute Based Access Control,” January 2014. [Online]. Available: https://nvlpubs.nist.gov/nistpubs/specialpublications/nist.sp.800-162.pdf. [Accessed 24 October 2023].
[22] Microsoft Corporation, “RMS System Overview,” 9 August 2010. [Online]. Available: https://learn.microsoft.com/en-us/previous-versions/windows/it-pro/windows-rights-management-services-rms/cc747671(v=ws.10). [Accessed 27 October 2023].

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

### Definitions

Process Injection (or injection, or DLL injection) is a technique used for running “guest” code within the address space of another “host” application by forcing it to load a dynamic link library (dll). Process Injection does not require a registration process nor a programming interface to be defined by the host application for the guest code to operate. The host application does not require any specific consideration for the guest code to execute. (cf. Addin) Addin (or plug-in, plugin, add-in, add-on, addon, extension, or COM addin) is a software component that adds a specific feature to an existing computer program. The existing computer program must supporta plug-in framework for the plug-in to operate. This support is provided by a defined addin registration technique and a defined programming interface. For the addin to operate it registers to the existing computer application using the registration technique and comply with the programming interface requirements. (cf. Dll Injection)

In one broad form of the invention there is provided a window capture controller, installable into an independent software application operating in a computing environment; said independent software application displaying a window; said independent software application is independent from said window capture controller; said independent software application executing inside process space allocated by said computer environment's operating system; wherein when said window capture controller is injected into said independent software application it remains resident in said independent software application and it remains receptive to commands to selectively control whether said software independent application's window can be captured or not by further screen capture software.

In a further broader form of the invention there is provided a window capture controller, installable into all independent software applications operating in a computing environment; said independent software application displaying a window; said independent software application is independent from said window capture controller; said independent software application executing inside process space allocated by said computer environment's operating system; wherein when said window capture controller is injected into said independent software application it remains resident in said independent software application and it remains receptive to commands to selectively control whether said software independent application's window can be captured or not by further screen capture software.

Preferably said window capture controller includes a user interface control inserted into user interface of said independent software application.

Preferably said user interface control is a slider switch, a push button, a checkbox, a menu item, or a toggle switch, a pre-designated combination of keyboard keys or some other control which allows the computer user to set the state of said window capture controller.

Preferably said user interface control provides a visual indicator, such as an icon or text or border colour or other graphical indicator, to the computer user to visualise the state of said window capture controller.

Preferably said user interface control provides an audio indicator, such as a beep or a series of beeps, to the computer user to recognise the state of said window capture controller.

Preferably said further screen capture software is a screen sharing application, such as Zoom, Teams, Slack, Webex, GoTo Meeting, Google Meet, TeamViewer, or other software that allows a computer user to share said computer's display or said software application's window with other people online.

Preferably said further screen capture software is a screen capture application, such as Snagit, ScreenPresso, Snipping Tool, Snip & Sketch, or other software that allows a computer user to capture an image of said computer's display or said software application's window.

Preferably said further screen capture application is a screen recording application, such as Camtasia, Loom, Captivate, or other software that allows a computer user to record said computer's display or said software application's window.

Preferably said window capture controller is installed into said software application using an addin registration technique specified by the software application provider.

Preferably said window capture controller is a COM Addin, said independent software application is a Microsoft Office application, such as Microsoft Word or Outlook, and the registration technique is COM registration.

Preferably said window capture controller is a browser addon, and said independent software application is a browser such as Google Chrome or Microsoft Edge.

Preferably said windows capture controller is a Web add-in, and said independent software application is a Microsoft Office desktop application, or a Microsoft Office web application.

Preferably said window capture controller controls capturing of said software application window by another process by using the SetWindowDisplayAffinity( ) Windows API, or the setting the ‘sharingType’ property of MacOS NSWindow, or some other mechanism which sets the capture attributes of an application window.

Preferably said window capture controller operates in the process space allocated to said independent software application.

Preferably said window capture controller is integral to said operating system.

In yet a further broad form of the invention there is provided a computer environment incorporating the window capture controller described above.

Preferably said window capture controller detects changes in the content displayed in said software application window.

Preferably said window capture controller detects changes in content displayed in said software application window by monitoring changes to said window's title.

Preferably changes to displayed content are triggered by user actions, such as closing an existing document and opening a new document in Microsoft Word, or changing the tab in a browser.

Preferably said window capture controller monitors changes to said window's title by regularly retrieving said window's title and comparing with the previously retrieved value.

Preferably said command capture controller monitors changes to said software application's window's title by monitoring messages posted to said software application's process, and detecting the WM_SETTEXT message, or some other message which commands the operating system to set the window title.

Preferably said window capture controller checks the attributes of the content in said software application and adjusts its state to stop capture of said software application's window when one or more said attributes meet predetermined conditions.

Preferably said content attribute is the security classification, or a security classification qualifier, or caveat, such as a releasability indicator caveat, or an eyes-only caveat, or a codeword caveat or a special handling caveat, or some other attribute which indicates the handling requirements of said software application's content.

Preferably said window capture controller, when capture is blocked, blocks the image of said software application window on the computer environment.

Preferably said window capture controller, when capture is blocked, replaces the capturable image of said software application window with another image.

Preferably said window capture controller replaces capturable image by setting said software application window to be transparent to capture by other processes, and creating a capturable window behind the software application window, wherein the capturable window contains the required replacement image.

Preferably said capture controller sets said software application to be transparent to capture by other processes by using the SetWindowDisplayAffinity( ) Windows command with the affinity value set to WDA_EXCLUDEFROMCAPTURE.

Preferably said window capture controller, when capture is allowed, places an identifier on said software application window, said identifier visible integral to said software application's window's capturable image.

Preferably said identifier is in the form of a watermark.

The window capture controller of claim 25, wherein said identifier is in the title bar of said software application's window.

Preferably said identifier includes, or is derived from, one or more of the following attributes: the presenter's identity, the presenter's organisation's identity, the time, the date, a meeting identifier.

Preferably said window capture controller redacts sensitive information in said software application's window when it is being shared.

Preferably said software application opens multiple documents simultaneously; and said window capture controller manages separate capture state for each displayed document.

Preferably said software application is Adobe Acrobat Reader, or Notepad++, or some other application which opens multiple documents simultaneously.

Preferably said software application is a web browser such as Google Chrome, Microsoft Edge, Safari or Mozilla Firefox, or some other application software which retrieves content from a resource and displays it.

In yet a further broad form of the invention there is provided a system to manage the capturability of application windows on a computer; said computer consisting of a processor, memory, storage, an operating system, a display, a user input device, such as mouse, keyboard, mousepad or touchscreen, a network connection, an independent software application, screen capture software, and a screen capture manager; wherein each of said independent software application, screen capture software and screen capture manager are independent applications, each executing in its own process space allocated by said operating system and said window capture controller as described above has been installed into said independent software application by said screen capture manager and said screen capture controller is managed by said screen capture manager.

In yet a further broad form of the invention there is provided a system to manage the capturability of application windows on a computer; said computer consisting of a processor, memory, storage, an operating system, a display, a user input device, such as mouse, keyboard, mousepad or touchscreen, a network connection, an independent software application, screen capture software; wherein each of said independent software application and screen capture software are independent applications, each executing in its own process space allocated by said operating system and said independent application has installed the window capture controller as described above into itself.

In yet a further broad form of the invention there is provided a system to manage the capturability of application windows on a computer; said computer consisting of a processor, memory, storage, an operating system, a display, a user input device, such as mouse, keyboard, mousepad or touchscreen, a network connection, an independent software application, screen capture software; wherein each of said independent software application and screen capture software are independent applications, each executing in its own process space allocated by said operating system and said screen capture software has installed the window capture controller as described above into said independent software application.

Preferably said screen capture manager uses a process injection technique to install said window capture controller into said independent software application to load a dynamically loaded library (DLL) into the independent application's process space.

Preferably the process injection technique uses the SetWindowsHookEx( ) Windows API.

Preferably the process injection technique uses the CreateRemoteThread( ) Windows API.

Preferably said screen capture manager processes images of said independent application window, and on detection of sensitive content in said software application window, signals said window capture controller to stop capture of said independent software application window.

Preferably said screen capture manager monitors said computer's network activity to ascertain when screen share is occurring.

Preferably said screen capture manager monitors said computer's network activity to identify the to identify screen sharing application.

Preferably computer network monitoring includes monitoring of network metrics and matching with predetermined values.

Preferably network metrics includes IP protocol, network port, destination IP address and data transfer rate, or some other network metrics used to identify screen sharing occurrence.

Preferably said operating system is the Microsoft Windows Operating System, and the said screen capture monitor uses the Windows Event Tracing API to monitor said computer's network activity.

Preferably said screen capture monitor registers an event callback; said event callback responding to network events.

Preferably said callback processes UDP network events.

Preferably said processing of UDP events includes calculating the UDP transmission rate per UDP destination port.

Preferably said screen capture monitor compares the UDP transmission rate per UDP destination port with predetermined values.

Preferably said processing of UDP events includes calculating the UDP transmission rate per destination IP address.

Preferably said screen capture monitor compares the UDP transmission rate per destination transmission address with predetermined values.

Preferably said processing of UDP events includes calculating the UDP transmission rate per system process.

Preferably said screen capture monitor compares the UDP transmission rate per system process with predetermined values.

Preferably said screen capture manager identifies said screen sharing application in use by monitoring said computer's process activity.

Preferably said screen capture manager identifies when screen sharing is occurring by monitoring creation of windows by said screen capture software.

Preferably said operating system is Microsoft Windows and said screen capture manager subscribes to UI Automation events using the IUIAutomation::AddAutomationEventHandler API and handles the UIA_Window_WindowOpenedEventId, whereby the event handler matches the window class name of the window with known values to ascertain that screen sharing has started.

Preferably said screen capture manager subscribes to UI Automation events using the IUIAutomation::AddAutomationEventHandler API and handles the UIA_Window_WindowOpenedEventId, whereby the event handler matches the process name and the window class name of the window with known values to ascertain that screen sharing has started.

Preferably said screen capture manager, on detection of screen sharing, presents a dialog to the user to select which of said independent software application windows to allow to be screen shared.

Preferably said independent application only displays content during screen share when said screen capture manager is active.

Preferably said screen capture manager during screen share samples and records one or more images of said independent application's window when said window capture controller allows capture.

Preferably said screen capture manager queries said computer's user calendar application to ascertain an identifier for a virtual meeting.

Preferably said screen capture manager, during a virtual meeting, queries a data store or web service for said virtual meeting's attendees.

Preferably said screen capture manager adjusts the state of said window capture controller when said virtual meeting's attendee's attribute meets a predetermined condition.

Preferably said virtual meeting's attendee's attribute is whether there is a confidentiality agreement in place between said virtual meeting's presenter and said virtual meeting's attendee.

Preferably said virtual meeting's attendee's attribute inherits from said virtual meeting's attendee's organisation's attribute.

Preferably said screen capture manager, during a virtual meeting, adjusts the state of said window capture controller based on the attributes of said application window's content.

Preferably said screen capture manager logs when said software application's window is shared.

Preferably said screen capture manager logs attendees of a virtual meeting.

Preferably said screen capture manager creates a capturable image of a said software application window by signalling the window capture controller to set said application window to be transparent for capture, and generating a capturable replacement window in another process displaying the required replacement image; said capturable replacement window behind said application window.

In yet a further broad form of the invention there is provided an Access Control System, whereby said Access Control System's control logic uses the presence of an active Screen Capture Manager, as described above, operating on the accessor's computer, as a control input to decide whether access to requested resources is granted.

Preferably said Access Control System is a Rights Management Service (RMS).

Preferably said Access Control System is an Attribute Based Access Control (ABAC) system.

Preferably said requested resource is a document or web page.

Preferably said requested resource is a part of a document or part of a web page.

Preferably said Access Control System's control logic requires the Screen Capture Manager, from any previous claim, on accessor's endpoint, not to screen share said resource.

Preferably said Screen Capture Manager has a user interface which allows said computer's user to control the capturability of said independent software application by said screen capture software.

Preferably said User Interface is a dialog listing independent software application windows.

Preferably said user interface lists independent software applications from a taskbar menu.

Preferably said user interface allows said user to control the sharing state of said independent software application by the user clicking on said independent software application's window with said computer's pointing device.

In yet a further broad form of the invention there is provided a system to monitor the capture of application windows on a computer; said computer consisting of a processor, memory, storage, an operating system, a display, an input device, such as mouse, keyboard, mousepad or touchscreen, a network connection, an independent software application, screen capture software, and a screen capture monitor; wherein: (a) each of said independent software application, screen capture software and screen capture monitor are independent applications, each executing in its own process space allocated by said operating system; and (b) said screen capture monitor monitors when said screen capture software shares said computer display.

In yet a further broad form of the invention there is provided a system to monitor the capture of application windows on a computer; said computer consisting of a processor, memory, storage, an operating system, a display, an input device, such as mouse, keyboard, mousepad or touchscreen, a network connection, an independent software application, screen capture software, and a screen capture monitor; wherein: (a) each of said independent software application, screen capture software and screen capture monitor are independent applications, each executing in its own process space allocated by said operating system; and (b) said screen capture monitor monitors when said screen capture software shares independent software application window.

Preferably said screen capture monitor detects that screen sharing has started by monitoring creation of windows by said screen capture software.

Preferably said screen capture monitor subscribes to UI Automation events using the Microsoft Windows IUIAutomation::AddAutomationEventHandler API and handles the UIA_Window_WindowOpenedEventId, whereby the event handler matches the window class name of the window with known values to ascertain that screen sharing has started.

Preferably said screen capture monitor subscribes to UI Automation events using the IUIAutomation::AddAutomationEventHandler API and handles the UIA_Window_WindowOpenedEventId, whereby the event handler matches the process name and the window class name of the window with known values to ascertain that screen sharing has started.

Preferably said screen capture monitor detects changes in content displayed in said independent software application window by monitoring changes to said window's title.

Preferably said window capture observer monitors changes to said independent software application window title by regularly retrieving said independent software application window's title and comparing with the previously retrieved value.

Preferably said window capture monitor subscribes to UI Automation events using the Microsoft Windows IUIAutomation::AddAutomationEventHandler API and handles the UIA_AutomationPropertyChangedEventId, whereby the event handler matches the control type identifier to UIA_WindowControlTypeId.

Preferably said window capture monitor retrieves said independent software application window's title using the Microsoft Windows WM_GETTEXT API.

Preferably said window capture monitor monitors changes in content displayed in said independent software application window by monitoring changes to said window's size.

In yet a further broad form of the invention there is provided a computer environment incorporating the window capture observer as described above.

Preferably said screen capture software is a screen sharing application, such as Zoom, Teams, Slack, Webex, GoTo Meeting, Google Meet, TeamViewer, or other software that allows a computer user to share said computer's display or said software application's window with other people online.

Preferably said screen capture monitor is part of said operating system.

Preferably said screen capture monitor is part of said screen sharing software.

Preferably said screen capture monitor monitors said computer's network activity to ascertain when screen share is occurring.

Preferably said screen capture monitor monitors said computer's network activity to identify the screen sharing application.

Preferably computer network monitoring includes monitoring of network metrics and matching with predetermined values.

Preferably said network metrics includes IP protocol, network destination port, destination IP address and data transfer rate, or some other network metrics used to identify screen sharing occurrence.

Preferably said operating system is the Microsoft Windows Operating System, and the said screen capture monitor uses the Windows Event Tracing API to monitor said computer's network activity.

Preferably said screen capture monitor registers an event callback; said event callback responding to network events.

Preferably said callback processes UDP network events.

Preferably said processing of UDP events includes calculating the UDP transmission rate per UDP destination port.

Preferably said screen capture monitor compares the UDP transmission rate per UDP destination port with predetermined values.

Preferably said processing of UDP events includes calculating the UDP transmission rate per destination IP address.

Preferably said screen capture monitor compares the UDP transmission rate per destination transmission address with predetermined values.

Preferably said processing of UDP events includes calculating the UDP transmission rate per system process.

Preferably said screen capture monitor compares the UDP transmission rate per system process with predetermined values.

Preferably said screen capture manager identifies said screen sharing application in use by monitoring said computer's process activity.

Preferably said window capture observer, when screen sharing is occurring, places an identifier on said independent software application window, said identifier visible integral to said independent software application's window's capturable image.

Preferably said identifier is in the form of a watermark.

Preferably said identifier is in the title bar of said software application's window.

Preferably said identifier includes, or is derived from, one or more of the following attributes: the presenter's identity, the presenter's organisation's identity, the time, the date, a meeting identifier.

Preferably said screen capture monitor logs when screen share is occurring.

Preferably said screen capture monitor logs when the content of said software application window changes while a screen share is occurring.

Preferably said screen capture monitor logs the window title of said software application's window.

Preferably said screen capture monitor logs attendees of a virtual meeting associated with said screen share.

In yet a further broad form of the invention there is provided a method of selectively preventing capture of content shown in a window of a software application executing on a computer; said method comprising:
injecting a window capture controller into said software application so that said screen capture controller operates in process space allocated to said software application by an operating system of said computer;
said window capture controller, once injected, is continuously receptive to commands to selectively protect capture of the content shown in the window of said software application;
said window capture controller remaining active in said software application while said software application is executing.

Preferably said window capture controller inserts a user interface control into user interface of said software application.

Preferably said user interface control is a slider switch, a push button, a checkbox, a menu item, or a toggle switch, a pre-designated combination of keyboard keys or some other control which allows the computer user to set the state of said window capture controller.

Preferably user interface control provides an audio indicator, such as a beep or a series of beeps, to the computer user to recognise the state of said window capture controller.

Preferably said window capture controller selectively protects capture of the content shown in an application window from screen capture software.

Preferably screen capture software is a screen sharing application, such as Zoom, Teams, Slack, Webex, GoTo Meeting, Google Meet, TeamViewer, or other software that allows a computer user to share said computer's display or said software application's window with other networked computers.

Preferably said screen capture software is a screen capture application, such as Snagit, ScreenPresso, Snipping Tool, Snip & Sketch, or other software that allows a computer user to capture an image of said computer's display or said software application's window.

Preferably said further screen capture application is a screen recording application, such as Camtasia, Loom, Captivate, or other software that allows a computer user to record said computer's display or said software application's window.

Preferably said window capture controller is injected into said software application using a process injection technique.

Preferably the process injection technique uses the CreateRemoteThread( ) Windows API.

Preferably the process injection technique uses the SetWindowsHookEx( ) Windows API.

Preferably said window capture controller is loaded into said software application using an addin registration technique specified by the software application provider.

Preferably said window capture controller is a COM Addin, said software application is a Microsoft Office application, such as Microsoft Word or Outlook, and the registration technique is COM registration.

Preferably said window capture controller is a browser addon, and said software application is a browser such as Google Chrome or Microsoft Edge.

Preferably said windows capture controller is a Web add-in, and said software application is a Microsoft Office desktop application, or a Microsoft Office web application.

Preferably said window capture controller selectively protects capture of the content shown in the window of said software application using the SetWindowDisplayAffinity( ) Windows API, or the setting the ‘sharingType’ property of MacOS NSWindow, or some other mechanism which sets the capture attributes of an application window.

Preferably said window capture controller is integral to said operating system.

Preferably said window capture controller detects changes in the content displayed in the window said software application.

Preferably said window capture controller detects changes in content displayed in said software application window by monitoring changes to said window's title.

Preferably changes to displayed content are triggered by user actions, such as closing an existing document and opening a new document in Microsoft Word, or changing the tab in a browser.

Preferably said window capture controller monitors changes to said window title of said software application by regularly retrieving said window's title and comparing with the previously retrieved value.

Preferably said window capture controller monitors changes to said window title of said software application by monitoring messages posted to said software application's process, and detecting the WM_SETTEXT message, or some other message which commands the operating system to set the window title.

Preferably said window capture controller checks the attributes of the content in said software application and adjusts its state to stop capture of said software application's window when one or more said attributes meet predetermined conditions.

Preferably said content attribute is the security classification, or a security classification qualifier, or caveat, such as a releasability indicator caveat, or an eyes-only caveat, or a codeword caveat or a special handling caveat, or some other attribute which indicates the handling requirements of said software application's content.

Preferably said window capture controller, when capture is protected, blocks the image of said software application window on the computer environment.

Preferably said window capture controller, when capture is protected, replaces the capturable image of said software application window with another image.

Preferably said window capture controller replaces capturable image by setting said software application window to be transparent to capture by other processes, and creating a capturable window behind the software application window, wherein the capturable window contains the required replacement image.

Preferably said capture controller sets said software application to be transparent to capture by other processes by using the SetWindowDisplayAffinity( ) Windows function with the affinity value set to WDA_EXCLUDEFROMCAPTURE.

Preferably said window capture controller, when capture is allowed, places an identifier on said software application window, said identifier visible integral to said software application's window's capturable image.

Preferably said identifier is in the form of a watermark.

Preferably said identifier is in the title bar of said software application's window.

Preferably said identifier includes, or is derived from, one or more of the following attributes: the presenter's identity, the presenter's organisation's identity, the time, the date, a meeting identifier.

Preferably said window capture controller redacts sensitive information in said software application's window when it is being shared.

Preferably said software application opens multiple documents simultaneously; and said window capture controller manages separate content protection state for each displayed document.

Preferably said software application is Adobe Acrobat Reader, or Notepad++, or some other application which opens multiple documents simultaneously.

Preferably said software application is a web browser such as Google Chrome, Microsoft Edge, Safari or Mozilla Firefox, or some other application software which retrieves content from a resource and displays it.

In a further broad form of the invention there is provided a method of detecting when screen sharing is occurring on a computer; said method comprising the following steps:
monitoring network activity of said computer;
comparing the network activity with activity profiles of known screen sharing applications.

Preferably activity profile includes IP protocol, network destination IP address, network destination port and data transfer rate, associated network process, or some other network metrics.

Preferably the step of monitoring network activity uses the Windows Event Tracing API.

Preferably the step of monitoring network activity includes calculation of UDP transmission rate per UDP destination port.

Preferably the UDP transmission rate per port is compared with predetermined values.

In yet a further broad form of the invention there is provided a method of detecting when screen sharing is occurring on a computer; said method comprising:
monitoring creation of application windows on said computer;
comparing the window attributes of created application windows with window profile attributes of known screen sharing applications

Preferably monitoring of application window creation is achieved using the Windows UIAutomation framework.

Preferably window profile attributes includes window process name, window class name and window caption.

### BRIEF DESCRIPTION OF THE DRAWINGS AND SAMPLE CODE

Embodiments of the present invention will now be described with reference to the accompanying drawings wherein:

FIG. 1 shows the elements of an independent application's main window with the additional menu item for window sharing in the system menu.

FIG. 2 shows a presenter's screen, with two applications, one with sharing disabled, the second with sharing enabled.

FIG. 3A shows the attendee view of the presenter's shared screen.

FIG. 3B shows a further the attendee view of the presenter's shared screen with more screen elements not shared.

FIG. 4 shows a component view of the system and the interaction between the components. Not every component is necessary for each usage scenario.

FIG. 5 shows the sequence of events at the start-up of the Screen Sharing Manager to instruct the Operating System to inject the Window Capture Controller into Independent Applications.

FIG. 5A shows the sequence of events when the Presenter activates an Independent Application, and the Independent Application's system menu is modified.

FIG. 5B shows the sequence of events when the Presenter activates an Independent Application's system menu to disable window sharing (hide a window).

FIG. 6 shows an audience view of the presenter's shared screen when the system has replaced the image of the presenter's application window.

FIG. 7 shows the sequence of events for the system to replace the image of the presenter's application window in the audience view.

FIG. 8 shows the sequence of events for the system to query for meeting attendees and their attributes.

FIG. 9 shows a Third-Party Application with redacted content. The content is redacted when the application window is shared.

FIG. 10 shows the sequence of events to redact the sensitive information when the presenter shares the application window.

FIG. 11 shows the sequence of events to hide a new top level application window. This sequence of events occurs when the Screen Capture Manager (407) is operating, and a new Software Application (403) starts.

FIG. 12 shows the sequence of events to hide existing top level application windows. This sequence of events occurs when one or more Software Applications (403) is operating, and the Screen Capture Manager (407) starts operation.

FIG. 13 shows the sequence of events for the Presenter (402) to control which Independent Software Applications' (403) Windows (412) to share. This sequence is triggered by the Independent Screen Sharing Application (404) starting to share some or all of the Presenter display.

FIG. 14 shows a flowchart describing the operation of the Screen Capture Manager's (407) Network Monitor (416) to detect when the Independent Screen Sharing Application (404) is sharing some or all of the Presenter's display.

FIGS. 15, 16 and 17 provide sample source code from the Window Capture Controller DLL. FIG. 15 has sample initialisation code called by the Screen Capture Manager when it starts, and the registered callback routine called by the Independent Software Application. FIG. 16 has sample code called when the Independent Software Application is activated, and the “Share” option is added to the Independent Software Application's System Menu. FIG. 17 has sample code which is called when the Presenter selects the “Share” item from the Independent Software Application's System Menu, and the Independent Software Application's Window is available for sharing, or hidden from sharing.

FIG. 18 provides sample code to show how the caption of the window can be used to control if a window can be captured.

FIG. 19 shows the program flow for automatically controlling whether a window is capturable.

FIG. 20 shows a sequence diagram of the events when the Screen Capture Manager injects the Window Capture Controller into an Independent Software Application.

FIG. 21 shows sample code from the Windows Capture Controller for injection into an Independent Software Application.

FIG. 22 shows a sequence diagram of the events when the Screen Capture Manager starts monitoring for windows created by Independent Screen Sharing Application.

FIG. 23 shows sample code for the Window Monitor to detect that screen sharing has started.

FIG. 24 shows a sequence diagram of the events when an Independent Software Application creates a new window and the Windows operating system's UIAutomation component fires an event so that the Screen Capture Manager injects a Window Capture Controller into the Independent Software Application.

### DETAILED DESCRIPTION OF THE PREFERRED EMBODIMENTS

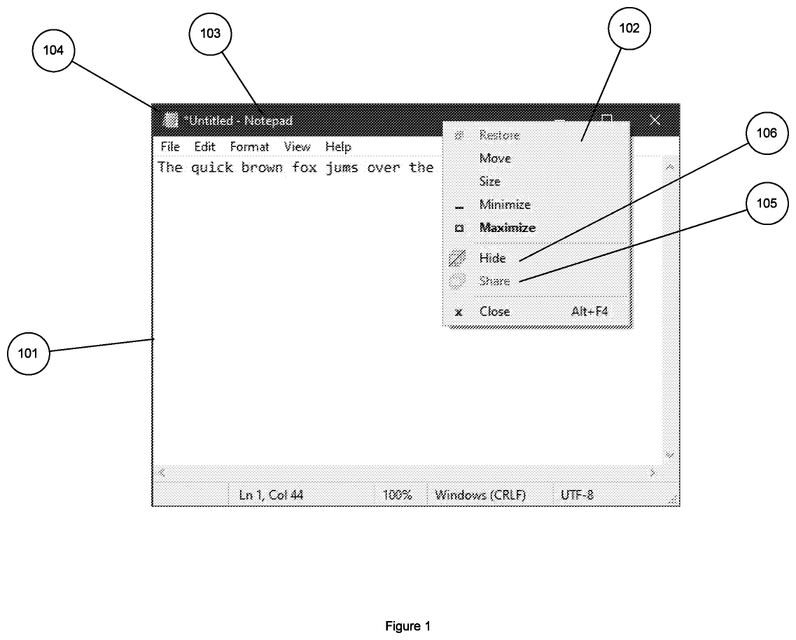

With reference to FIG. 1, an independent software application, such as Microsoft Notepad, executes on a computer and displays a window (101). The window has a title bar (103) and an application icon (104). The window has a system menu (102) which the user activates by right-mouse-clicking on the title bar, or by mouse-clicking on the application icon. The Window Capture Controller (unshown) executes inside the independent software application's process space and inserts additional “Share” (105) and “Hide” (106) menu items into the system menu.

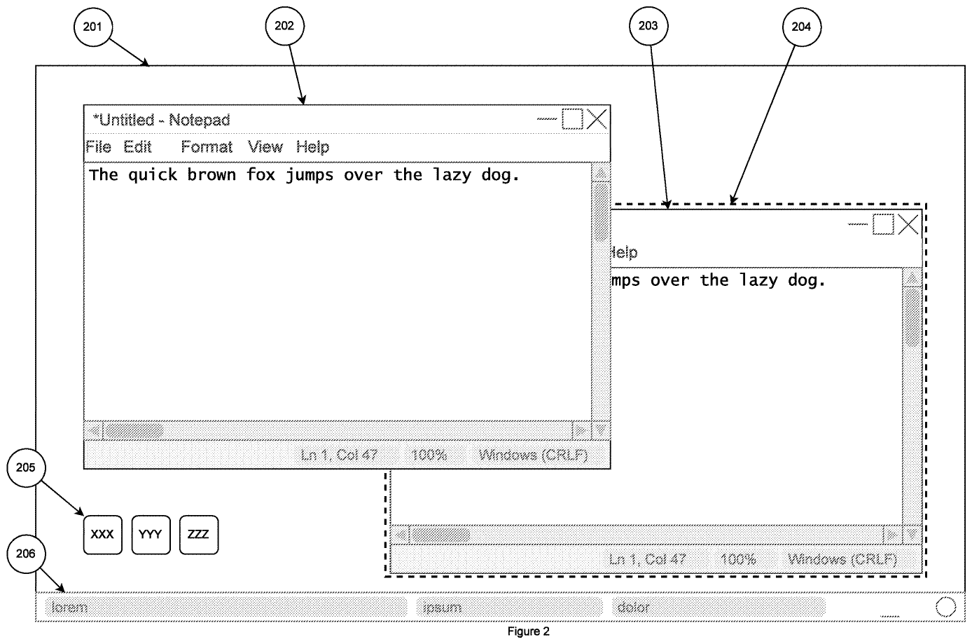

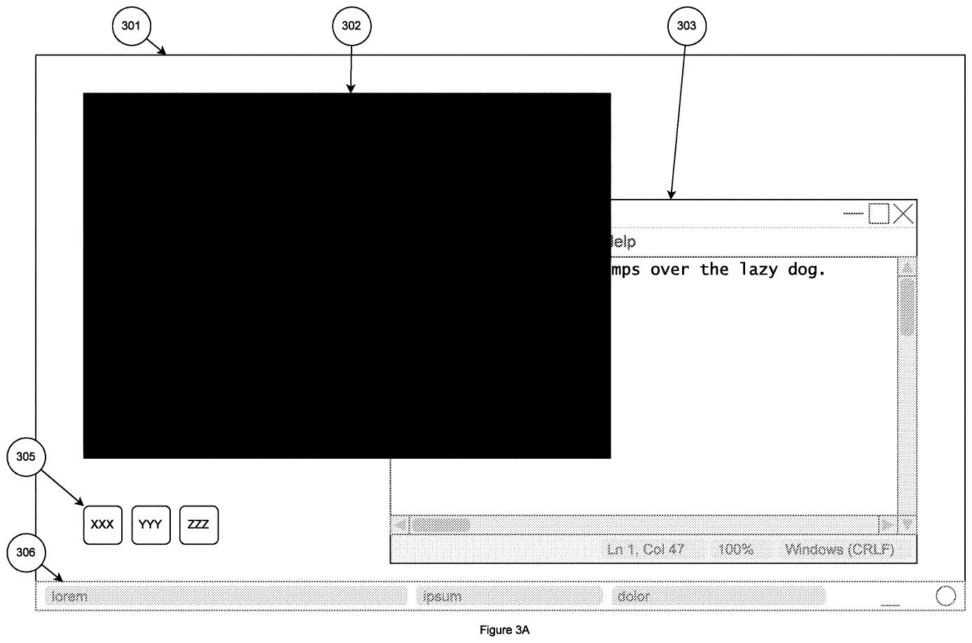

With reference to FIG. 2, the presenter's computer display (201) shows two independent software applications' windows. The first application (202) (Windows Notepad.exe) has sharing disabled, the second application (202), also Windows Notepad.exe, has sharing enabled. Both applications' windows are visible to the presenter. The border of the shared application window is bounded by a dashed line (204) to alert the present that that window is shared. The display (201) also shows desktops icons (205) and a taskbar (206).

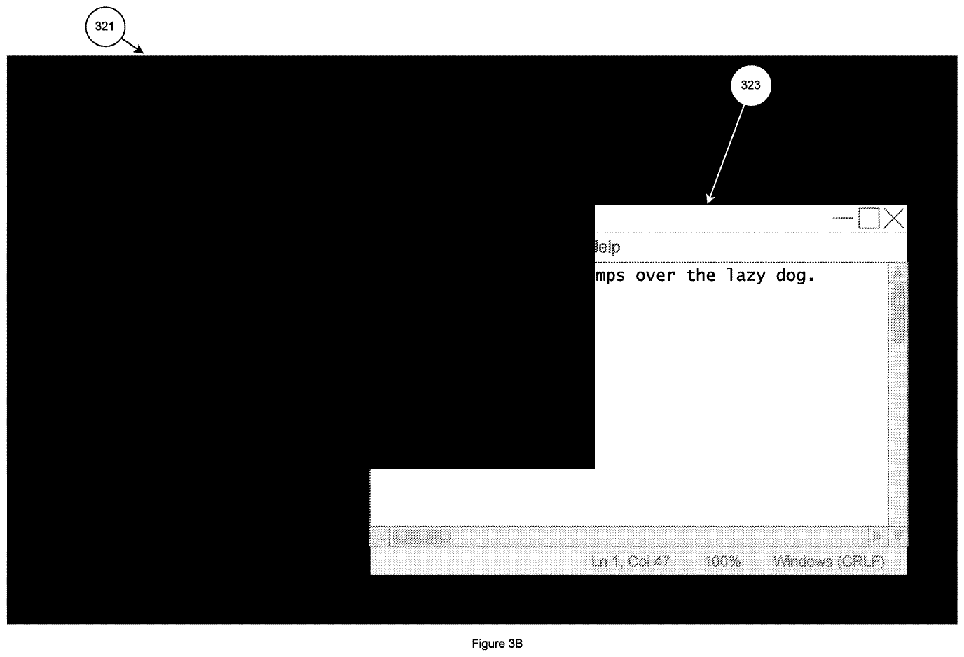

In one embodiment of the present invention, the attendee's view of the presenter's display has the image of any hidden software application window replaced with a black rectangle. With reference to FIG. 3A, the attendee view (301) of the presenter's display from FIG. 2 as displayed by Independent Screen Sharing Software to the meeting attendee is shown. The first application's window (302) is blacked out, as the presenter has disabled sharing. The second application's window (303) is visible, except where hidden by the first application's window, as the presenter has allowed sharing of that window. The desktop and its icons (305) and the taskbar (306) remain shared in the attendee view.

In a further embodiment of the present invention, the attendee's view of presenter's display has the image of any hidden software application window, including the desktop and taskbar windows, replaced with black rectangles. With reference to FIG. 3B, the attendee view (321) of the presenter's display from FIG. 2 as displayed by Independent Screen Sharing Software to the meeting attendee is shown. The first application's window (Item 202 from FIG. 2) is blacked out, as the presenter has disabled sharing. The second application's window (303) is visible, except where hidden by the first application's window, as the presenter has allowed sharing of that window. The attendee view does not display the desktop and its icons, nor the taskbar (Items 205 and 206 from FIG. 2), as these items have not been shared by the presenter.

In a further embodiment of the present invention, hidden windows may be transparent to Independent Screen Sharing Software. Instead of being replaced with a black rectangle in the attendee view, the attendee view can see the image behind the hidden window.

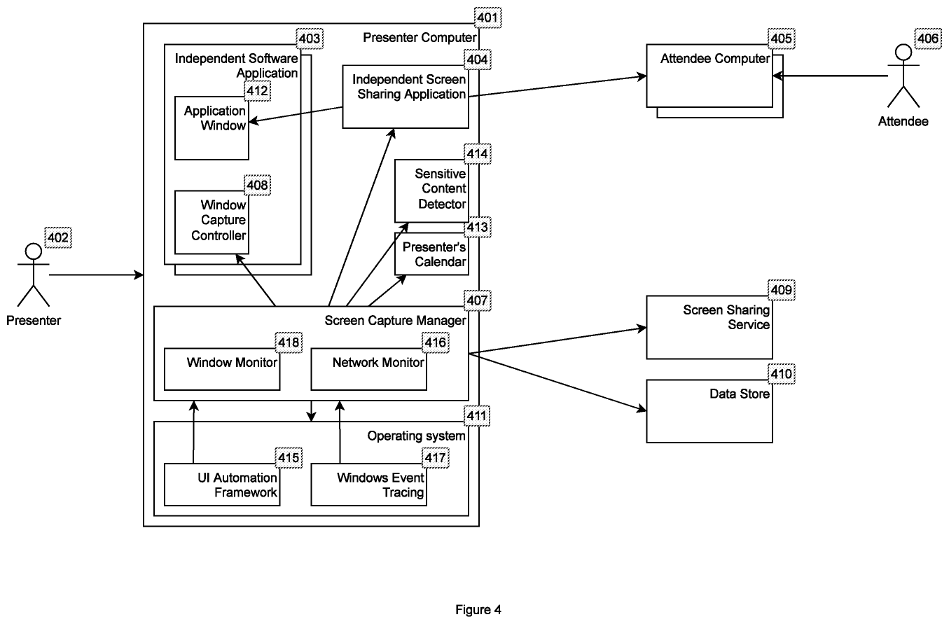

With reference to FIG. 4, the Presenter (402) uses a Computer (401) to operate an Independent Software Application (403), which has one or more Application Windows (412). As per FIG. 1, each Application Window has a title bar, an optional application icon and a system menu. The Presenter (402) shares the Application Window (412) using Independent Screen Sharing Software (404) to virtual meeting Attendees (406) at remote Attendee Computers (405). A network (unshown) connects the Presenter's Computer (401) to the Attendee Computers (405) and to the Independent Screen Sharing Service (409) and to the Data Store (410).

A Screen Capture Manager (407) operates on the Presenter's Computer (401) to manage the sharing of Application Windows (403). The Screen Capture Manager (407) uses the Operating System (411) to insert a Window Capture Controller (408) into each Independent Software Application (403). The Window Capture Controller (408) enables, and conversely, disables, access from an independent process, in this case, from the Independent Screen Sharing Software (404) to the Third-Party Application Window (412).

In a preferred embodiment of the present invention the Presenter's Computer (401) has an Intel-based processor, and the Operating System (411) is Windows 10, but could also be Windows 11. The Independent Screen Sharing Software (404) is Microsoft Teams, but could also be Zoom, Webex, Slack or Google Meet. The independent applications (403) could be any of, but not limited to, Microsoft Word, Excel, PowerPoint, Outlook, Notepad, Calculator, Chrome (browser), Edge and Adobe Reader.

In a preferred embodiment of the present invention, the Screen Capture Manager (407) is an executable, and the Window Capture Controller (408) is a dynamically linked library (dll).

In a preferred embodiment of the present invention, the Screen Capture Manager (407) has a Network Monitor (416) to monitor the Presenter Computer's (407) network activity. The Network Monitor detects when the Independent Screen Sharing Application (404) is sharing some or all of the Presenter Computer's display. The Network Monitor (416) subscribes to network events raised by the Window Event Tracing (417) component of the Windows operating system.

In a preferred embodiment of the present invention, the Screen Capture Manager (407) has a Window Monitor (418) to monitor the Presenter's Computer (401) for the creation of windows created by the Independent Screen Sharing Application (404). The Window Monitor subscribes to user interface events raised by the UI Automation Framework (415) component of the Windows Operating System.

In a preferred embodiment of the invention, the Screen Capture Manager (407) has its own user interface (not shown here) for the presenter to control which independent software application windows (412) (including the desktop and taskbar) can be shared by the Independent Screen Sharing Application (404).

The Screen Capture Manager (407) queries the Presenter's Calendar (413) for a meeting identifier. In a preferred embodiment of the present invention, the Presenter's Calendar is Microsoft Outlook. In a further embodiment of the present invention, the Presenter's Calendar is Google Calendar.

The Screen Capture Manager (407) queries the Screen Sharing Software service (409) for meeting Attendees (406).

The Screen Capture Manager (407) logs a summary of window sharing. This can include the title of the Application Window (412) and Attendee (406) identifiers. In a preferred embodiment of the present invention the log is stored in the Presenter's Computer (401). In another form of the invention the log is transmitted over the network to a logging service (unshown).

The Screen Capture Manager (407) queries a Data Store (410) for meeting attendee attributes, such as security clearance or geographical location, or business unit. It uses these attributes with predetermined criteria to decide if sharing is allowed or not. In one form of the invention the Data Store (410) is Microsoft Active Directory. In another form of the invention, the Data Store (410) is Azure Active Directory.

The Window Capture Controller (408) queries the Application (403) for content. The Window Capture Controller (408) using a Sensitive Content Detector (414) to detect sensitive content in the Application (403). The Window Capture Controller (408) redacts sensitive contents in the Application's Window (412).

In a further embodiment of the present invention, the Screen Capture Manger (407) is replaced with a screen capture monitor, which detects when Independent Screen Sharing Software (404) is actively sharing Independent Software Application's (403) windows.

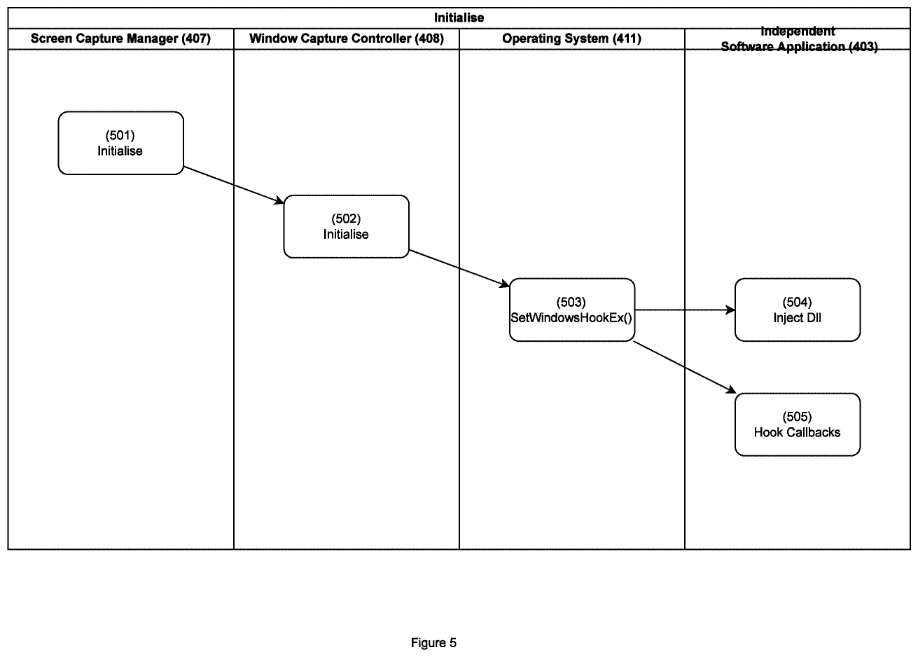

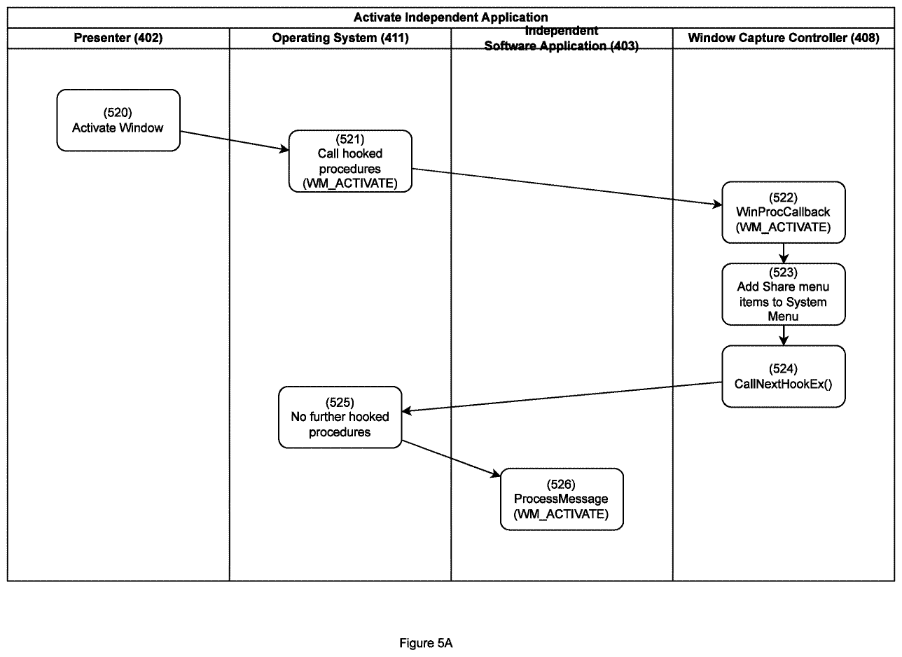

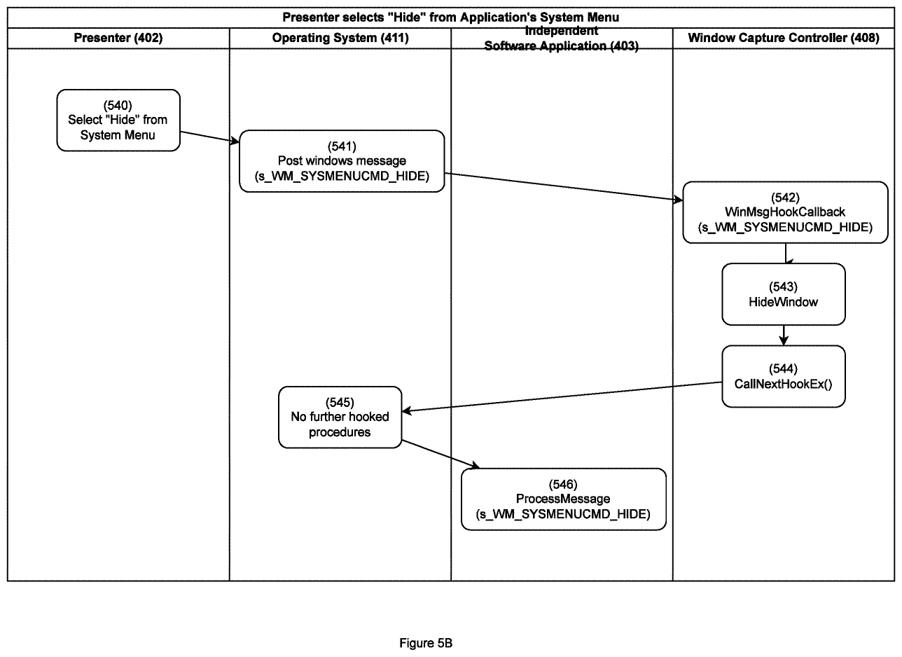

With reference to FIG. 5, when the Screen Capture Manager (407) starts, it loads the Window Capture Controller (408) library, and calls its initialisation function (501). The Window Capture Controller's initialisation function calls the Windows operating system method SetWindowsHookEx( ) (502). The method call identifies the Window Capture Controller's library and specifies the hook procedure to be associated with all existing processes. The Operating System (411) injects the Window Capture Controller's library and the specified hooks into existing processes, and new processes as they are created. During initialisation, hook procedures are specified for Windows Procedure calls.

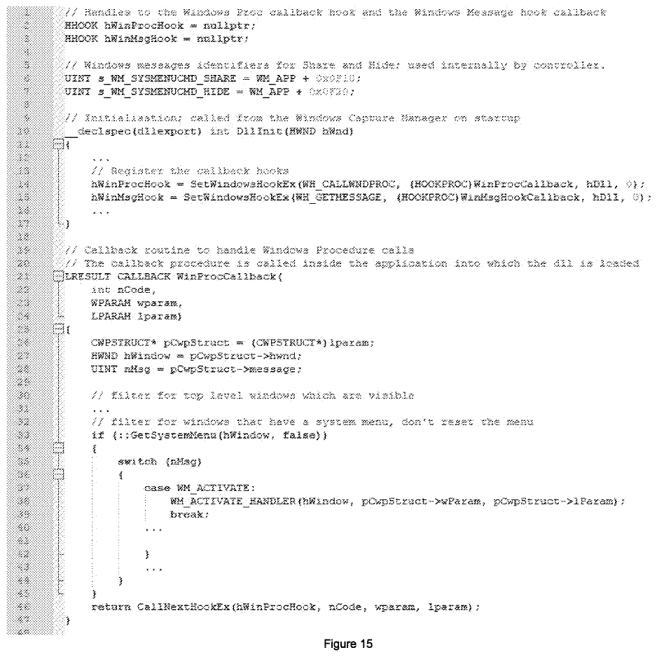

With reference to FIG. 15, from the Window Capture Controller, lines 9-19 show the controller's initialisation. The call to SetWindowsHookEx( ) at line 14 does a number of things. As used here, it injects the Window Capture Controller's DLL into other processes. The first argument installs the hook procedure into the hook chain that monitors messages before the system sends them to the destination window procedure. The second argument is the pointer to the hook procedure “WinProcCallback( )”. The third argument is the handle to the Windows Sharing Controller's DLL. The fourth argument associates the hook procedure with all existing threads running in the same desktop as the calling thread, and for future application threads. Similarly, the call at line 15 registers the hook procedure “WinMsgHookCallback( )”. This callback monitors message posted to the process's message queue.

With reference to FIG. 5A, the sequence of events to add the “Share” menu item to the Software Application's System menu is shown. In this case, the trigger is when the Presenter (402) activates the Software Application's window (520), but other events could be used. The Operating System (411) calls registered Windows Process hooked procedure (callback) with the WM_ACTIVATE message (521), including the Window Capture Controller's WinProcCallback (522). The callback adds the “Share” menu item to the Application's System Menu (523) and any other menu items, such as the “Hide” menu item, and completes by calling the next callback (524). When there are no further callbacks (525), the Operating System passes the WM_ACTIVATE message to the Software Application to process (526).

In a similar way, not shown, the operating system sends the WM_ACTIVATE message is sent with different parameters when a window is deactivated. In this case, the Window Capture Controller responds by removing the “Share” menu item and other relevant menu items from the Software Application's System Menu.

The operation of the WinProcCallback is further described by the sample of FIG. 15, lines 21-47. When called, the function retrieves the handle of the window (line 27), and the windows message to be processed (line 28). Additional code, not shown here, ensures that the function responds to messages message destined for top level windows, and that have a system menu, and ignores messages for other windows. Chen [9] describes a mechanism to identify top-level windows. If the message is WM_ACTIVATE, the function WM_ACTIVATE_HANDLER( ) is called (line 38).

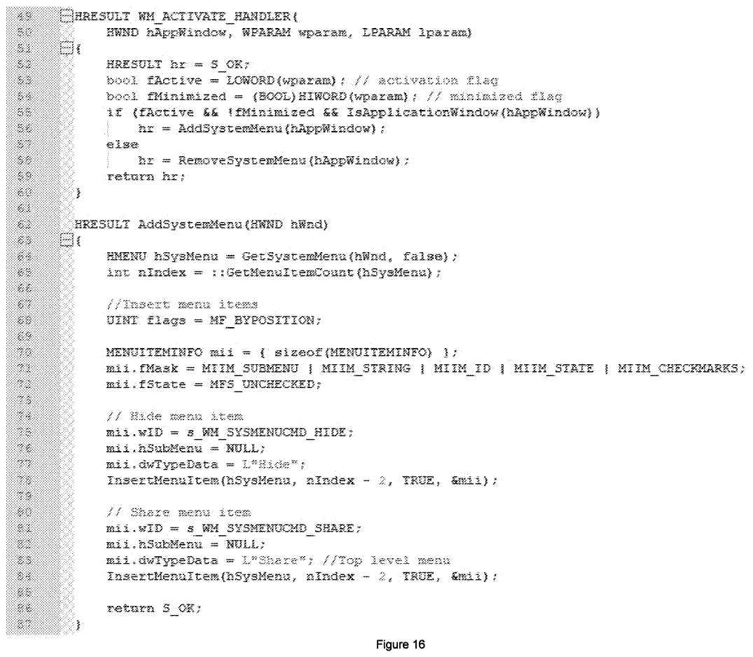

The code in FIG. 16 shows the operation of WM_ACTIVATE_HANDLER( ). Line 55 detects when the window is active and not being minimised. In this case the system menu is modified by adding the “Hide” and “Share” menu items (line 56), otherwise the items are removed from the system menu (line 53).

Lines 62 through 87 show the operation of the function to add the “Hide” and “Share” menu items. Line 64 retrieves the existing system menu. Line 65 gets the number of items already in the menu. Lines 67 through 77 set up the menu item structure, included its identifier (line 73) and the text for the menu item (line 77). Line 78 inserts the “Hide” menu item into the window's system menu. Similarly, lines 80-84 insert the “Share” menu item into the System Menu.

With reference to FIG. 5B, the sequence of events is shown when the Presenter activates the Independent Application's system menu to hide the application's window (thus disabling sharing) sharing via a screen sharing application. The Presenter (402) activate the Software Application's System Menu by mouse-clicking on the application icon in the Application window's title bar, or by right-mouse-clicking in the Application window's title bar. The System Menu is presented including the “Hide” menu item. When the Presenter selects the “Hide” menu item (540), the Operating System (411) calls the registered Windows Message Process hooked procedures (callbacks) with the s_WM_SYSMENUCMD_HIDE message (541), including the Window Capture Controller's WinMsgHookCallback (542). The callback sends the command to the Operating System to hide the window from screen sharing (543) and completes by calling the next callback (544). When there are no further callbacks (545), the Operating System passes the s_WM_SYSMENUCMD_HIDE message to the Independent Application to process (546).

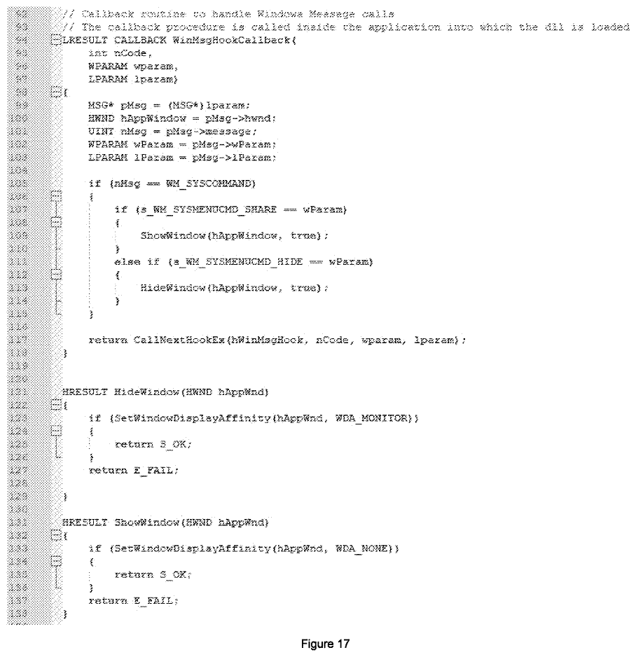

The operation of the WinMsgHookCallback( ) is further described by the sample of FIG. 17, lines 94-118. When called, the function retrieves the handle of the window (line 100), and the windows message to be processed (line 101). The callback asserts that the Windows message is the WM_SYSMENUCMD message (line 105). The “wparam” parameter refers to whether the window should be hidden or shared, based on the menu item identifier the System menu item that was activated. This parameter switches whether HideWindow( ) (line 109) or ShowWindow( ) (line 113) is called.

Lines 121 through 127 show the operation of HideWindow( ). The parameter “hAppWnd” refers to the window to be hidden. The call to SetWindowDisplayAffinity( ) (line 93) instructs the operating system to disallow sharing of the specified application window. The parameter “WDA_MONITOR” instructs the operating system that window content can not be captured and therefore shared by another process.

Lines 131 through 138 show the operation of ShowWindow( ). The parameter “hAppWnd” refers to the window to be shown. The call to SetWindowDisplayAffinity( ) (line 93) instructs the operating system to allow sharing of the specified application window. The parameter “WWDA_NONE” instructs the operating system that window content has no restrictions on which process can capture the window content.

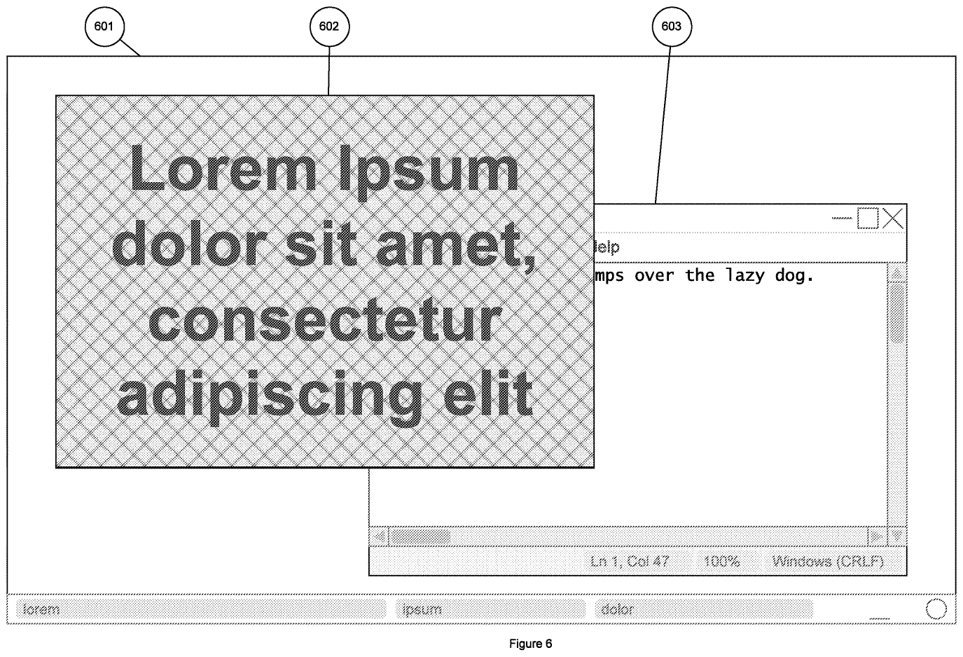

With reference to FIG. 6, an audience view of the presenter's shared screen (601) is shown in the case when the system has replaced the image of the presenter's application window. The first application's window shows a replacement image (602), as sharing has been disabled for that application by the presenter. The second application's window (603) is visible, except where hidden by the first application's window.

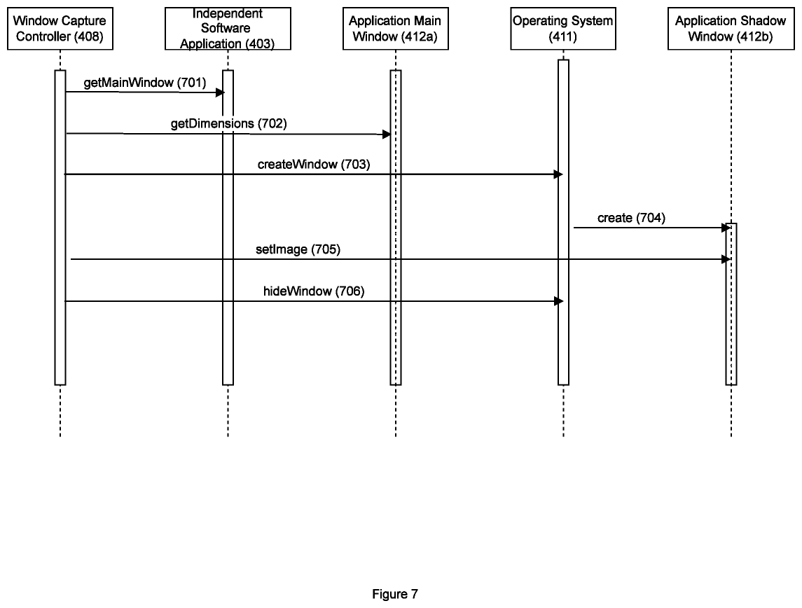

With reference to FIG. 7, the sequence of events is shown for the system to replace the image of the presenter's application window in the audience view.

The Windows Capture Controller (408) queries the Independent Software Application (403) for its main window (701). The Independent Software Application (403) returns the identifier of its Main Window (412a). The Windows Capture Controller (408) retrieves the dimensions of the Main Window (412a) (702). The Window Capture Controller (408) requests a new window (703) from the operating system (411). The requested window is of the same dimensions as the Main Window, but behind it. The Operating System (411) creates (704) the new window, the Application Shadow Window (412b). The Windows Sharing Controller (408) sets the desired replacement image in the Application Shadow Window (412b) (705). The Windows Capture Controller (408) instructs the Operating System (411) to make the Application Main Window (412a) transparent to screen sharing software (706), thus showing the desired replacement image to the remote audience.

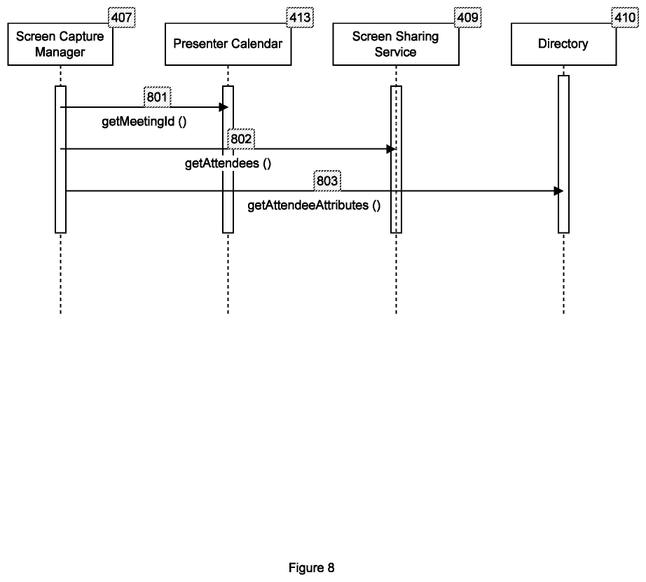

With reference to FIG. 8, the sequence of events is shown for the system to query for meeting attendees and their attributes.

The Screen Capture Manager (407) queries the Presenter's Calendar (413) for the meeting identifier of the current meeting (801). The Screen Capture Manager queries the Independent Screen Sharing Software Service (409) for the Meeting Attendees (802). The Screen Capture Manager (407) queries the Directory (410) for attendees' attributes (803).

In one embodiment of the present invention, the technique described above is used for logging the attendees of a virtual meeting, with whom the window content of Independent Software Application is shared.

In a further embodiment of the present invention, the technique described above is used to compare attendees' attributes with window content attributes, so policy can be enforced as to whether the content can be shared or not.

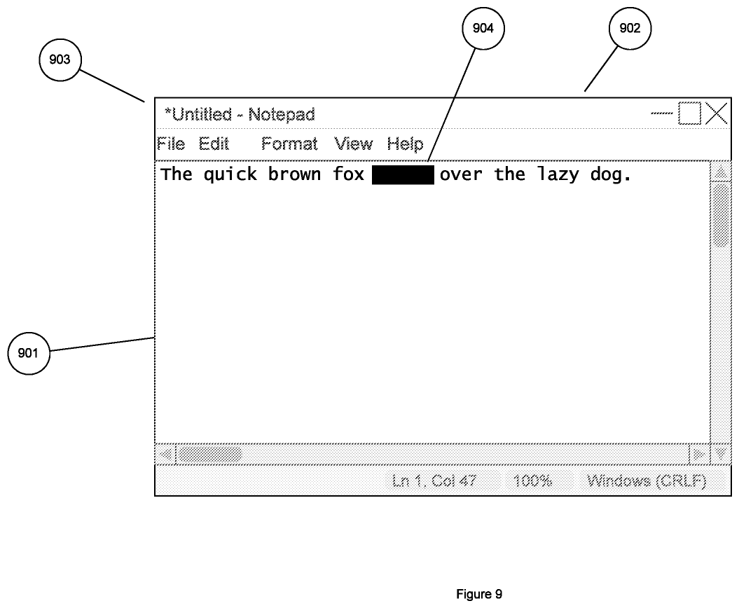

With reference to FIG. 9, an Independent Software Application (901), in this case Notepad. exe, is shown with redacted content (904). The content is redacted when the application window is shared.

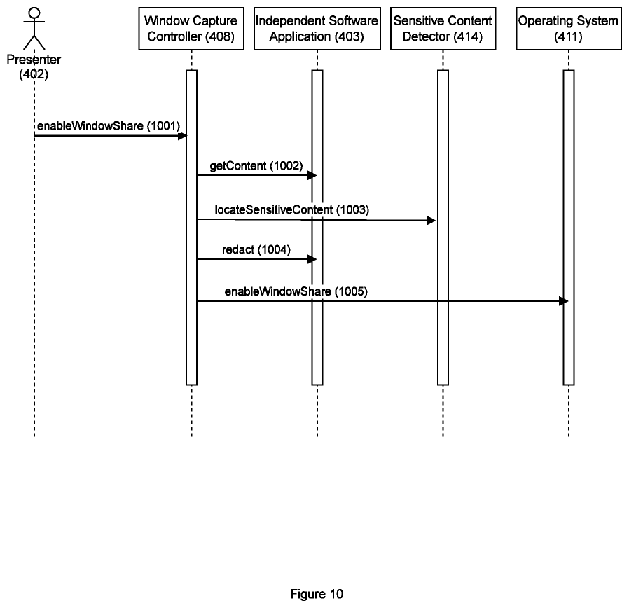

With respect to FIG. 10, the sequence of events is shown to redact the sensitive information when the presenter shares the application window.

The Presenter (402) instructs the Window Capture Controller (408) to allow sharing (1001). The Windows Capture Controller (408) retrieves content from the Independent Software Application (403) (1002). The Window Capture Controller (408) passes the content to the Sensitive Content Detector (414) to locate any sensitive content. The Window Capture Controller (408) redacts the locations (1004) in the Independent Software Application (403) detected by the Sensitive Content Detector (414). The Window Capture Controller (408) instructs the Operating System (411) to enable sharing of the Independent Software Application's (403) window.

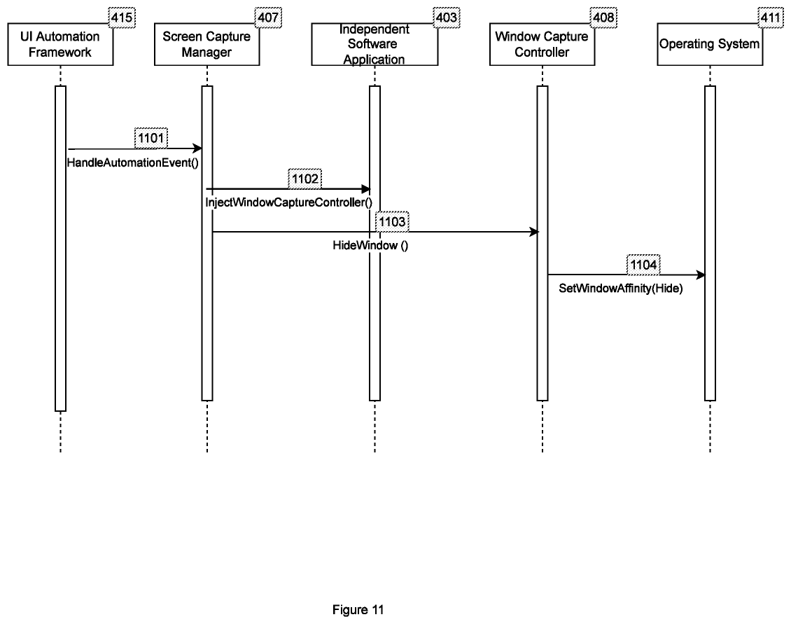

In a further embodiment of the present invention, the Screen Capture Manager (407) manages Application Windows (412) which start after the Screen Capture Manager (407) is operating. The Screen Capture Manager (407) detects when a new Independent Software Application (403) Window (412) is created and injects a Windows Capture Controller into the Independent Software Application's (403) process. This is shown in FIG. 11.

The Screen Capture Manager (407) subscribes to the Windows UI Automation Framework (415) events using the IUIAutomation::AddAutomationEventHandler( ) API and handles the UIA_Window_WindowOpenedEventId. When a new application window is created, the UI Automation Framework (415) calls the callback function (1101) that the Screen Capture Manager (407) registered during subscription. The callback function asserts that the window identified in the call is a top-level window. If so, the Screen Capture Manager (407) and injects (1102) a Window Capture Control (408) into the process space of the Independent Software Applications (403) associated with the top-level window. To set the default behaviour of the Application Window (412) from being shared, the Screen Capture Manager (407) instructs the Window Capture Controller (408) to hide the window (1103. The Window Capture Controller (408), operating in the Independent Software Application's (403) process space, uses the Windows Operating System's (411) SetWindowsAffinity( ) API call (1104) to hide the applications window.

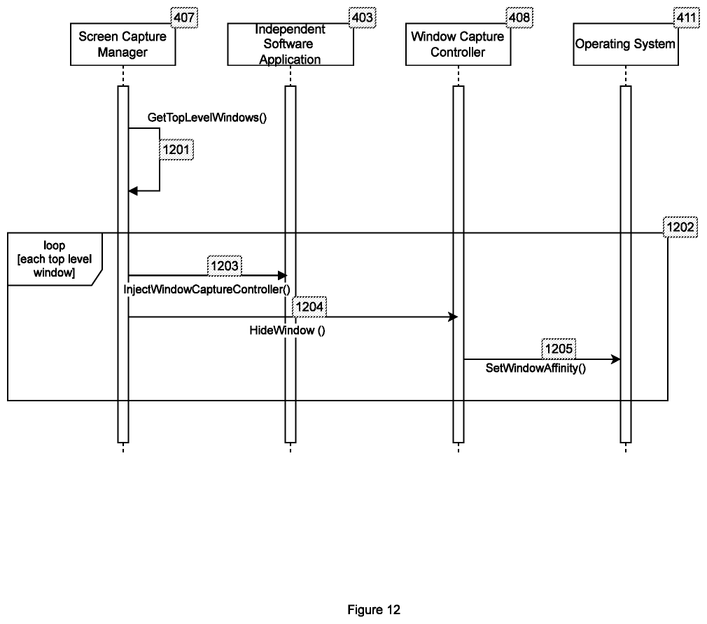

In a further embodiment of the present invention, the Screen Capture Manager (407) manages Application Windows (412) which have started before the Screen Capture Manager (407) starts operating. The Screen Capture Manager (407) detects the presence of existing Independent Software Application (403) Window (412) and injects a Windows Capture Controller into the Independent Software Application's (403) process. This is shown in FIG. 12.

The Screen Capture Manager (407) gets the list of top-level windows (1201). It iterates through the list (1202) and injects a Window Capture Control (408) into the process space of each of the Independent Software Applications (403) associated with the top-level window. To set the default behaviour of the Application Window (412) from being shared, the Screen Capture Manager (407) instructs the Window Capture Controller (408) to hide the window (1204). The Window Capture Controller (408), operating in the Independent Software Application's (403) process space, uses the Windows Operating System's (411) SetWindowsAffinity( ) API call (1205) to hide the application's window.

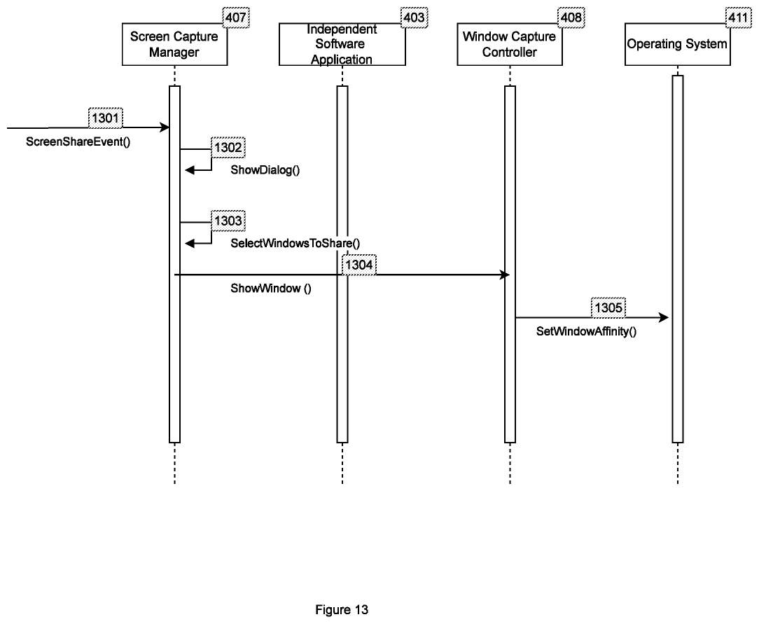

In further embodiment of the present invention, the Screen Capture Manager (407) controls, via Presenter (402) instruction, which Application Windows (412) to share and which to hide from the Independent Screen Sharing Application (404), and thus which windows are shared or hidden from meeting attendees (406). This is shown in FIG. 13.

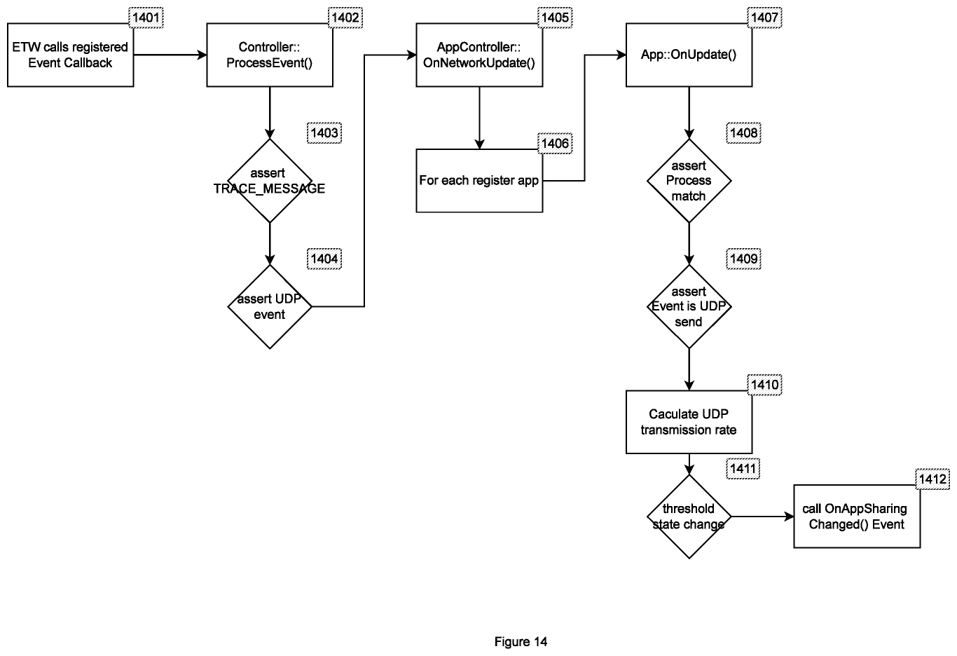

The Screen Capture Manager (407) receives a trigger to display its dialog, shown in FIG. 13 as ScreenShareEvent( ) (1301). The Network Monitor (FIG. 4, Item 416), or the Window Monitor (FIG. 4, Item 418) might trigger this event, when either monitor detects that screen sharing has started. (Refer FIG. 14). Alternatively, the Presenter (402) might activate the Screen Capture Manager's dialog by activating a control on the Taskbar (FIG. 2, Item 206). The Screen Capture Manager (407) displays a dialog (1302) which lists the top-level Application Window (412) of each Independent Software Application (403) which the Presenter (402) is executing, including the desktop and taskbar windows. For each top-level Application Window (412) listed in the dialog, the Presenter (402) can choose to show or hide the window from the Attendee's (406) view. In the sequence shown in FIG. 13, the Presenter (402) selects one or more top level Application Windows to share. When the presenter selects an Application Window to share from the dialog, the Screen Capture Manager (407) determines the related Independent Software Application's (403), and sends a ShowWindow( ) notification to the Window Capture Controller (408) which it had injected into the Independent Software Application's (403) process (Refer FIGS. 11 and 12). The Window Capture Controller (408), operating in the Independent Software Application's (403) process space, uses the Windows Operating System's (411) SetWindowsAffinity( ) API call (1205) to show the application's window.

In a further embodiment of the present invention, the Screen Capture Monitor's (407) Network Monitor (416) monitors when screen sharing is occurring by monitoring the Presenter Computer's (401) network activity. This is shown in in the flowchart in FIG. 14.

The Network Monitor (416), during initialisation, registers an event callback function with the Windows Event Tracing API, configured to respond to network events. When a network event occurs, the Windows Event Tracing component calls the Network Monitor's (416) registered callback function (1401). The callback function processes the event (1402). If the callback function asserts the event is a TRACE_MESSAGE (1403) and that it is a UDP event (1404), it notifies the Network Monitor (416) that a network update has occurred (1405). The Network Monitor (416) iterates through its list of registered screen sharing application profiles, where each profile includes the Screen Sharing Application's process name and UDP destination port for screen sharing. For example, Zoom's process name is “zoom.exe”, it uses UDP ports 3478 and 3479 as the data channel to transfer video, audio and screen sharing [10]; Microsoft Teams' process name is “teams.exe” and uses UDP ports 3478 through 3481 [11], and Webex uses UDP ports 5004 and 9000 [12]. TeamViewer [13] uses TCP and UDP ports 5938. For each screen sharing application profile (1407), if the Network Monitor asserts that the process name in the event data matches the profile's process name (1408), and that the event is a UDP send event (1409), and that destination port in the event data matches the profile's UDP destination port, it uses the number of bytes in the specified in the event data, along with number of bytes from previous notifications, and notification timing data to calculate the UDP screen sharing transmission rate for the Screen Sharing Application (404). When the transmission rate crosses a predetermined threshold, say from 0 to 1 kByte/sec, it notifies the Screen Capture Manager (407) that screen sharing is occurring (refer FIG. 13).

In a further embodiment of the present invention, the above-described technique for monitoring screen sharing network activity is used to notify the Screen Capture Monitor that screen sharing is occurring.

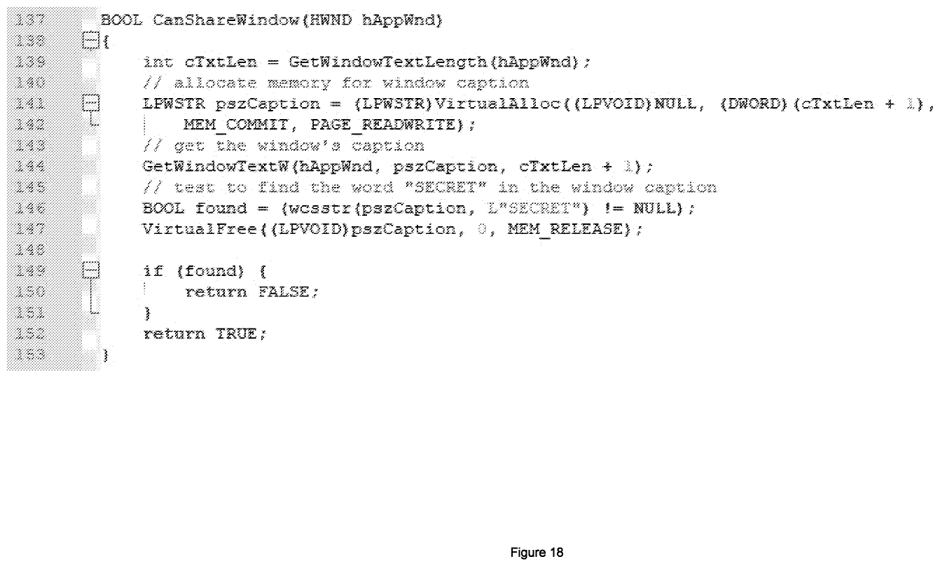

In some instances, it is necessary to never allow capture and sharing of windows with specific attributes. FIG. 18 shows sample code which operates in the Window Capture Controller. It retrieves the caption of the window (line 144), and tests if the keyword “SECRET” occurs in the window caption. If the keyword is detected, the window is not capturable, and the function returns false. Otherwise, the window is capturable. To enforce this policy, this function is used prior to inserting and enabling the “Share” menu item (FIG. 16, AddSystemMenu( )), as well as when the controller receives a message to share the window (FIG. 17, ShowWindow( )).

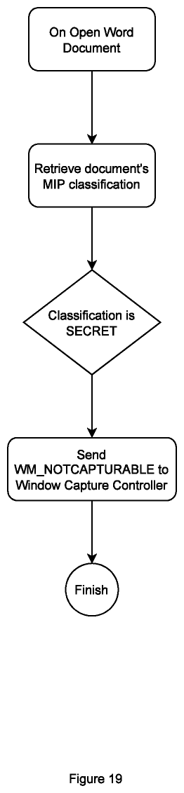

In some instances, it is necessary to never allow capture and sharing of a window which is displaying a file or document with specific attributes. An example is where a MS Word document is classified with Microsoft Information Protection (MIP), and classified as SECRET, it must never be shared via screen sharing applications. FIG. 19 shows a flowchart of the flow of a COM addin that is loaded into Microsoft Word. When a document is opened, the COM addin responds and queries the MIP classification attributes of the document. If the classification is SECRET, it sends a windows message to the Window Capture Controller to disallow capturing. When the Window Capture Controller processes the message, it hides the window (as per FIG. 17, HideWindow( )) and it modifies the system menu to disable the Share menu item (similar to FIG. 16, AddSystemMenu( )).

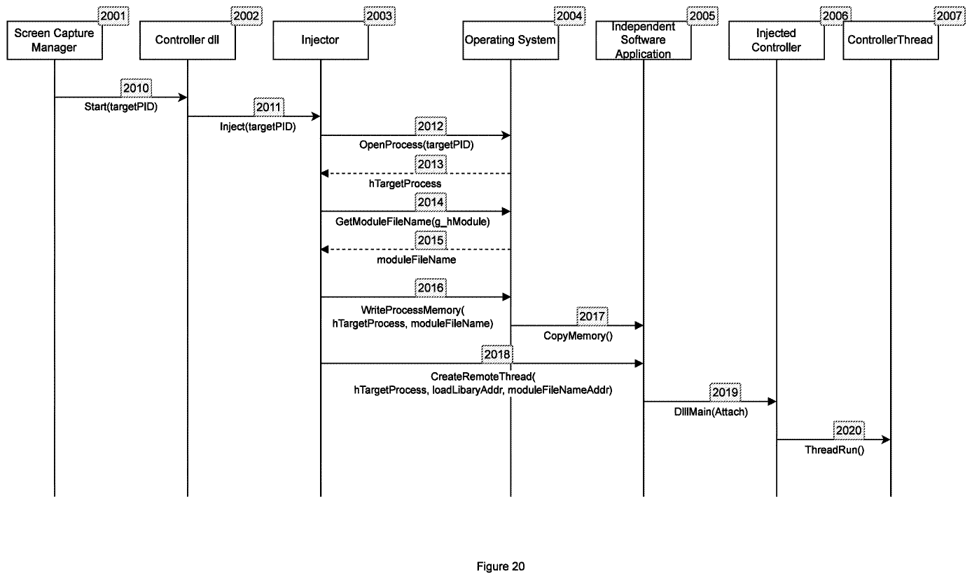

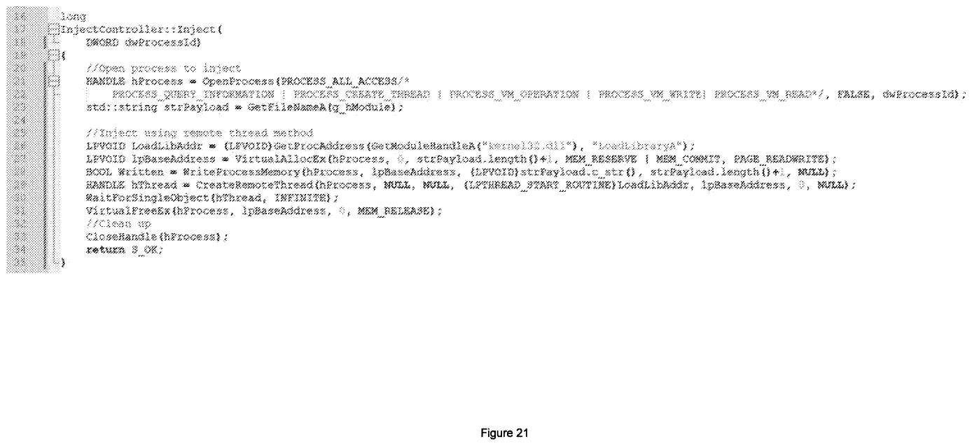

In a further embodiment of the present invention, the Screen Capture Manager injects the Screen Capture Controller into an Independent Software Application on a Windows operating system using the CreateRemoteThread( ) Windows function. FIG. 20 shows the sequence of events for the injection, and sample source code is shown in FIG. 21.

Referring to FIG. 20: The Screen Capture Manager (2001, alt FIG. 4 Item 407) calls the Screen Capture Controller (2002) dll's Start( ) exported function (2010). The process identifier of the Independent Software Application is the argument of the functional call. The Injector (2003) is a class in the Screen Capture Controller dll. The Start( ) function constructs the Injector (2003) and calls the Injector's Inject( ) method (2011). The Injector uses the Windows OpenProcess( ) function to retrieve the handle of the Independent Software Application's process (2012 and 2013). The Injector retrieves the file path of the Screen Capture Controller dll using the Windows GetModuleFileName( ) function (2014 and 2015). The Injector copies the Screen Capture Controller dll's pathname into the Independent Software Application's process memory using the Windows WriteProcessMemory( ) function (2016 and 2017). The Injector calls the Windows CreateRemoteThread( ) function (2018), specifying the Independent Software Application's process identifier, the address of the operating system kernal's LoadLibrary( ) function, and the address of the Window Capture Controller's dll's pathname. When the dll is loaded into the Independent Software Application's process and attached (2019), the controller's thread starts (2020).

Referring FIG. 21, showing sample code for the Windows Capture Controller to inject itself into an Independent Software Application's process. Line 21 uses the OpenProcess( ) Windows function to open a handle to the target process with full access rights. Line 23 calls an internal method to retrieve the path name to the Windows Capture Controller dll. The internal method uses the GetModuleFileName( ) Windows function. Line 26 retrieves the library address of the LoadLibrary( ) procedure from the kernal.dll. Line 27 allocates memory in the Independent Software Application's process for the Windows Capture Controller dll file path. Line 28 copies the Windows Capture Controller dll file path into the allocated memory. Line 29 calls the CreateRemoteThread( ) Windows function. This call executes the LoadLibrary( ) function in the Independent Software Application's process, which loads the Windows Capture Controller dll, which starts the controller's thread.

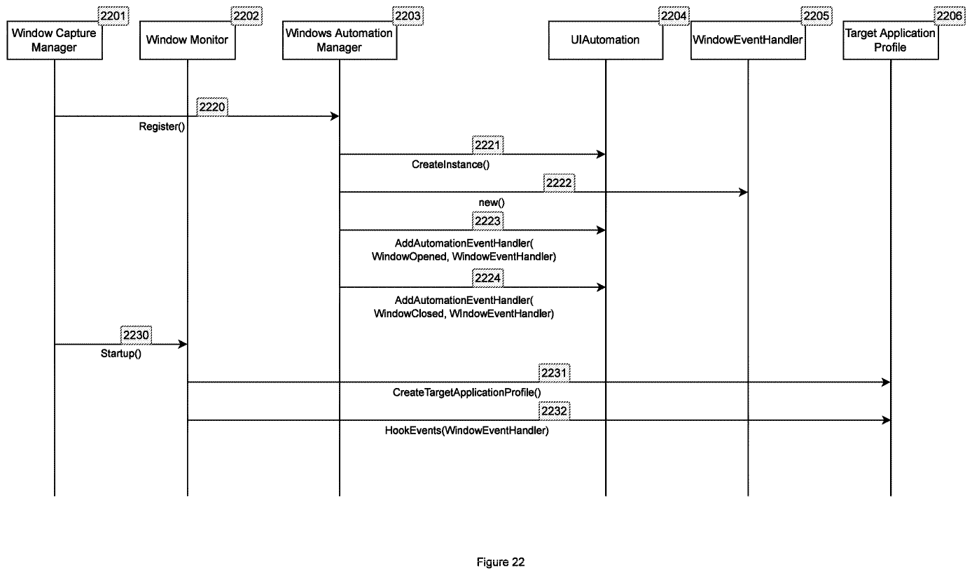

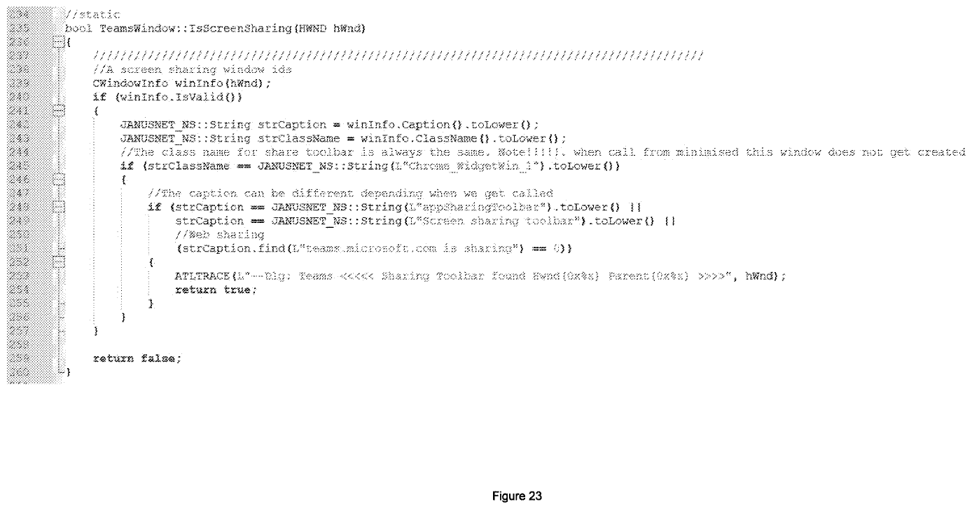

In a further embodiment of the invention, the Screen Capture Manager (FIG. 4, Item 407) detects when the Independent Screen Sharing Application (FIG. 4, Item 404) shares the presenter's display or part of the presenter's display. This sequence of events to initialise the monitoring is shown in FIG. 22, whereby the Screen Capture Monitor uses the Windows operating system's UI Automation framework to trigger events when windows are created or closed. When such an event occurs, the Target Application Profile processes the event information to check attributes of the window against predefined values, to confirm if the created window is a screen sharing window. Sample code for this process for confirmation that a Microsoft Teams sharing window has been created is shown in FIG. 23. If a screen sharing window has been created, this can be used to trigger a screen sharing event as shown in FIG. 13.

With reference to FIG. 22, the Screen Capture Manager (2201) calls the Windows Automation Manager (2203) to register (2220). It creates an instance (2221) of the Windows UIAutomation class (2204), and subsequently creates a WindowEventHandler (2205, 2225). The Windows Automation Manager registers the WindowEventhandler to the UIAutomation object for both the WindowOpen and WindowClosed events (2223, 2224). The Window Capture Manager (2201) starts the Window Monitor (2202, and FIG. 4, Item 416), which creates one or more TargetApplicationProfiles (2206). Each TargetApplicationProfile corresponding to an Independent Screen Sharing Application, such as MS Teams, Zoom or Slack. The Window Monitor hooks the WindowHandlerEvents to each of the TargetApplicationprofiles (2232), so they are notified when windows are opened and closed.

With reference to FIG. 23, the MS Teams TargetApplicationProfile has received notification that a window has been opened and is passed the handle to the opened window. Line 239 constructs an internal CWindowInfo object, based on the Windows GetWindowInfo( ) function. Line 242 extracts the window caption from the window information. Line 243 extracts the class name from the window information. Line 245 asserts that the window class name is “Chrome_WidgetWin_1”. Lines 248 through 251 asserts that the window caption is one of “appSharingToolbar” or “Screen Sharing Toolbar” or “teams.microsoft.com is sharing”. If both class name and caption name assertions are correct, then the function returns true, confirming that MS Teams has opened a screen sharing window.

Similarly, to confirm a Slack screen sharing window, the window caption is “Slack” and the window class name is “Chrome_WidgetWin_1”. To confirm a Zoom screen sharing window, the window caption is “Screen Sharing Meeting Controls”, and the window class name is “ZPFloatToolbarClass”.

In a further embodiment of the present invention, the above-described technique for monitoring screen sharing window creation is used to notify the Screen Capture Monitor that screen sharing is occurring.

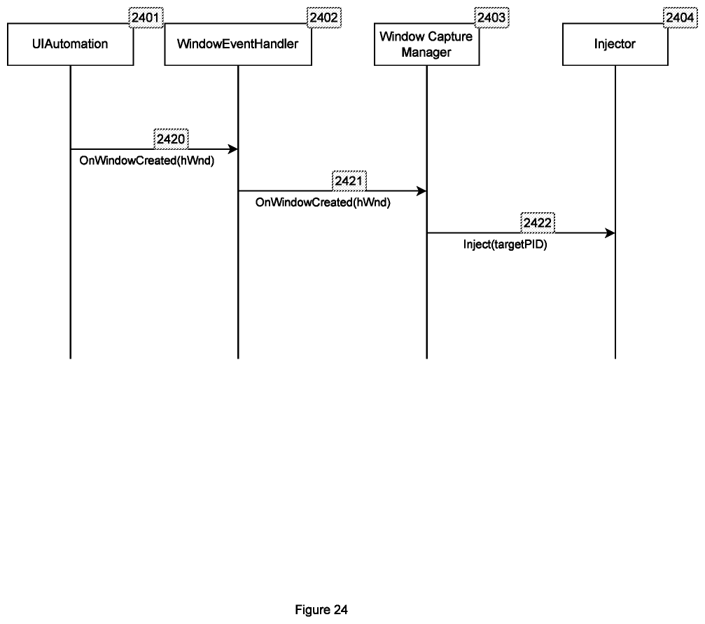

In a further embodiment of the invention, the Screen Capture Manager (FIG. 4, Item 407) responds to an Independent Software Application (FIG. 4, Item 403) starting and creating a new Application Window (FIG. 4, Item 412), so that the Screen Capture Manager can inject a Window Capture Controller (FIG. 4, Item 408) into the Independent Software Application and control capture of that window by Independent Screen Sharing Application (FIG. 4, Item 404) or further window capture applications. This sequence of events is depicted in FIG. 24.

During initialisation, the Window Capture Manager has registered for window open and close events with the Windows operating systems UIAutomation framework, as previously described (FIG. 22). When an Independent Software Application starts and creates a new Application Window the operating system notifies the UIAutomation framework (2401), which in turn notifies the WindowsEventHandler (2402) a window has been created. The WindowsEventHandler (2402) is part of the Window Monitor (418). The WindowsEventHandler notifies (2421) the WindowCaptureManager (2403). The Window Capture Manager calls the Window Capture Controller to inject itself into the Independent Software Application (2422). The injection process is described in FIG. 20.

1. A window capture controller, installable into an independent software application operating in a computing environment; said independent software application displaying a window; said independent software application is independent from said window capture controller; said independent software application executing inside process space allocated by an operating system of said computer environment; wherein when said window capture controller is injected into said independent software application it remains resident in said independent software application and it remains receptive to commands to selectively control whether said window can be captured or not by further screen capture software; wherein said window capture controller and said further screen capture software operate independently from each other; and wherein said operating system operates independently from said screen capture software.

2. (canceled)

3. The window capture controller of claim 1, wherein said window capture controller includes a user interface control inserted into user interface of said independent software application.

4. The window capture controller of claim 3, wherein said user interface control is a slider switch, a push button, a checkbox, a menu item, or a toggle switch, a pre-designated combination of keyboard keys or some other control which allows the computer user to set the state of said window capture controller.

5. The window capture controller of claim 3, wherein said user interface control provides a visual indicator, such as an icon or text or border colour or other graphical indicator, to the computer user to visualise the state of said window capture controller.

6. The window capture controller of claim 3, wherein said user interface control provides an audio indicator, such as a beep or a series of beeps, to the computer user to recognise the state of said window capture controller.

7. The window capture controller of claim 1, wherein said further screen capture software is a screen sharing application, such as Zoom, Teams, Slack, Webex, GoTo Meeting, Google Meet, Team Viewer, or other software that allows a computer user to share a display of said computer or said window with other people online.

8. The window capture controller of claim 1, wherein said further screen capture software is a screen capture application, such as Snagit, ScreenPresso, Snipping Tool, Snip & Sketch, or other software that allows a computer user to capture an image of a display of said computer or said window.

9. The window capture controller of claim 1, wherein said further screen capture application is a screen recording application, such as Camtasia, Loom, Captivate, or other software that allows a computer user to record a display of said computer or said window.

10. The window capture controller of claim 1, wherein said window capture controller controls capturing of said software application window by another process by using the SetWindowDisplay Affinity( ) Windows API, or the setting the ‘sharingType’ property of MacOS NSWindow, or some other mechanism which sets the capture attributes of an application window.

11. The window capture controller of claim 1, wherein said window capture controller operates in the process space allocated to said independent software application.

12. The window capture controller of claim 1, wherein said window capture controller is integral to said operating system.

13. A computer environment incorporating the window capture controller of claim 1.

14. The window capture controller of claim 1, wherein said window capture controller detects changes in a content displayed in said software application window.

15. The window capture controller of claim 13, wherein said window capture controller detects changes in a content displayed in said window by monitoring changes to a title of said window.

16. The window capture controller of claim 1, wherein changes to a displayed content are triggered by user actions, such as closing an existing document and opening a new document in Microsoft Word, or changing the tab in a browser.

17. The window capture controller of claim 14, wherein said window capture controller monitors changes to a title of said window by regularly retrieving said title and comparing with the previously retrieved value.

18. The window capture controller of claim 14, wherein said command capture controller monitors changes to a title of said software application window by monitoring messages posted to a process of said software application, and detecting the WM_SETTEXT message, or some other message which commands the operating system to set the title.

19. The window capture controller of claim 1, wherein said window capture controller checks the attributes of a content in said software application and adjusts its state to stop capture of said window when one or more said attributes meet predetermined conditions.

20. The window capture controller of claim 18, wherein a content attribute is the security classification, or a security classification qualifier, or caveat, such as a releasability indicator caveat, or an eyes-only caveat, or a codeword caveat or a special handling caveat, or some other attribute which indicates the handling requirements of said content.

21. The window capture controller of claim 1, wherein said window capture controller, when capture is blocked, blocks the image of said software application window on the computer environment.

22. The window capture controller of claim 20, wherein said window capture controller, when capture is blocked, replaces the capturable image of said software application window with another image.

23. The window capture controller of claim 20, wherein said window capture controller replaces capturable image by setting said software application window to be transparent to capture by other processes, and creating a capturable window behind the software application window, wherein the capturable window contains the required replacement image.

24. The window capture controller of claim 1, wherein said capture controller sets said software application to be transparent to capture by other processes by using the SetWindowDisplay Affinity( ) Windows command with the affinity value set to WDA_EXCLUDEFROMCAPTURE.

25.-156. (canceled)
